(19) United States
(12) Patent Application Publication
(10) Pub. No.: US 2026/0312659 A1
(43) Pub. Date: Oct. 8, 2026

(54) BAYESIAN OPTIMIZATION FOR BEAM TRACKING

(71) Applicant: Nokia Solutions and Networks Oy, Espoo (FI)

(72) Inventors: Lorenzo Maggi, Paris (FR); Qiping Zhu, Wheaton, IL (US); Arndt Koblitz, Cambridge (GB); Daniel Andrews, Chatham, NJ (US)

(21) Appl. No.: 18/998,599

(22) PCT Filed: Jul. 28, 2022
(86) PCT No.: PCT/US2022/074245

§ 371 Date: Jan. 27, 2025

(51) Int. Cl. H04B 7/06; H04B 17/318

(52) U.S. Cl. CPC H04B 7/0695; H04B 17/328

(57) ABSTRACT

An apparatus including circuitry configured to connect to a user equipment; initialize an inference model for beam selection using past reference signal received power measurements of a set of available beams used with a network node, the past reference signal received power measurements performed with user equipment; infer, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmit data to the user equipment using one of the beams within the set of available beams, based at least partially on the probability distribution.

### TECHNICAL FIELD

The examples and non-limiting example embodiments relate generally to communications and, more particularly, to Bayesian optimization for beam tracking.

### BACKGROUND

It is known to transmit data from a network node to a user equipment using a beam, and from the user equipment to the network node using a beam, in a wireless communication network.

### SUMMARY

In accordance with an aspect, an apparatus includes at least one processor; and at least one memory including computer program code; wherein the at least one memory and the computer program code are configured to, with the at least one processor, cause the apparatus at least to: connect to a user equipment; initialize an inference model for beam selection using past reference signal received power measurements of a set of available beams used with a network node, the past reference signal received power measurements performed with a plurality of user equipment; infer, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmit data to the user equipment using one of the beams within the set of available beams, based at least partially on the probability distribution of reference signal received power inferred for the at least one beam within the set of available beams.

In accordance with an aspect, a user equipment includes at least one processor; and at least one memory including computer program code; wherein the at least one memory and the computer program code are configured to, with the at least one processor, cause the user equipment at least to: connect to a network node; infer, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmit data to the network node using one of the beams within the set of available beams, based at least partially on the probability distribution of reference signal received power inferred for the at least one beam within the set of available beams.

In accordance with an aspect, a method includes connecting to a user equipment; initializing an inference model for beam selection using past reference signal received power measurements of a set of available beams used with a network node, the past reference signal received power measurements performed with a plurality of user equipment; inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmitting data to the user equipment using one of the beams within the set of available beams, based at least partially on the probability distribution of reference signal received power inferred for the at least one beam within the set of available beams.

In accordance with an aspect, a method includes connecting to a network node; inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmitting data to the network node using one of the beams within the set of available beams, based at least partially on the probability distribution of reference signal received power inferred for the at least one beam within the set of available beams.

In accordance with an aspect, an apparatus includes means for connecting to a user equipment; means for initializing an inference model for beam selection using past reference signal received power measurements of a set of available beams used with a network node, the past reference signal received power measurements performed with a plurality of user equipment; means for inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and means for transmitting data to the user equipment using one of the beams within the set of available beams, based at least partially on the probability distribution of reference signal received power inferred for the at least one beam within the set of available beams.

In accordance with an aspect, an apparatus includes means for connecting to a network node; means for inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and means for transmitting data to the network node using one of the beams within the set of available beams, based at least partially on the probability distribution of reference signal received power inferred for the at least one beam within the set of available beams.

In accordance with an aspect, a non-transitory program storage device readable by a machine, tangibly embodying a program of instructions executable with the machine for performing operations is provided and described, the operations including connecting to a user equipment; initializing an inference model for beam selection using past reference signal received power measurements of a set of available beams used with a network node, the past reference signal received power measurements performed with a plurality of user equipment; inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmitting data to the user equipment using one of the beams within the set of available beams, based at least partially on the probability distribution of reference signal received power inferred for the at least one beam within the set of available beams.

In accordance with an aspect, a non-transitory program storage device readable by a machine, tangibly embodying a program of instructions executable with the machine for performing operations is provided and described, the operations including connecting to a network node; inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmitting data to the network node using one of the beams within the set of available beams, based at least partially on the probability distribution of reference signal received power inferred for the at least one beam within the set of available beams.

### BRIEF DESCRIPTION OF THE DRAWINGS

The foregoing aspects and other features are explained in the following description, taken in connection with the accompanying drawings.

FIG. 1A is a block diagram of one possible and non-limiting system in which the example embodiments may be practiced.

FIG. 1B shows Tx/Rx beam pairs in both the downlink direction and uplink direction, with multiple Rx beams.

FIG. 1C shows Tx/Rx beam pairs in both the downlink direction and uplink direction, with one Rx beam.

FIG. 1D shows a Tx beam grid and Rx beam grid in the uplink and downlink directions.

FIG. 1E shows a Tx beam grid and Rx beam grid in the uplink and downlink directions, where the Rx beam grid has one beam.

FIG. 1F shows Tx beams for downlink and Tx beams for uplink.

FIG. 2 depicts spatial closed-loop beam tracking, a focus of the examples described herein.

FIG. 3 depicts temporal open-loop beam prediction.

FIG. 4 shows AI/ML based beam prediction in time domain, specifically predicting the ranking of the best beams in future time instances.

FIG. 5A is a flowchart illustrating the method described herein.

FIG. 5B shows an example probability distribution for one beam, or for one beam pair.

FIG. 6 shows an example of RSRP for 128 DFT beams at a given time instant.

FIG. 7 shows a simulation configuration for data generation.

FIG. 8A shows a beam pattern of gNB narrow beams in 0 degree azimuth cut.

FIG. 8B shows a beam pattern of gNB narrow beams in 0 degree elevation cut.

FIG. 9A is a graph illustrating that beams sampled per time slot remain fixed irrespective of performance.

FIG. 9B is a graph illustrating a gap in terms of dB loss to the maximum attainable RSRP.

FIG. 10A is a graph showing beams sampled per slot (bps) showing convergence to the minimum allowable beam set size (4 bps) in observed cases.

FIG. 10B is a graph showing performance in terms of dB loss with respect to the maximum attainable RSRP (available in hindsight) showing rapid performance convergence, where RSRP measurements are taken every 80 ms.

FIG. 11 is an example apparatus configured to implement the examples described herein.

FIG. 12 shows a representation of an example of non-volatile memory media.

FIG. 13 is a method performed with a network node, based on the examples described herein.

FIG. 14 is a method performed with a user equipment, based on the examples described herein.

### DETAILED DESCRIPTION OF EXAMPLE EMBODIMENTS

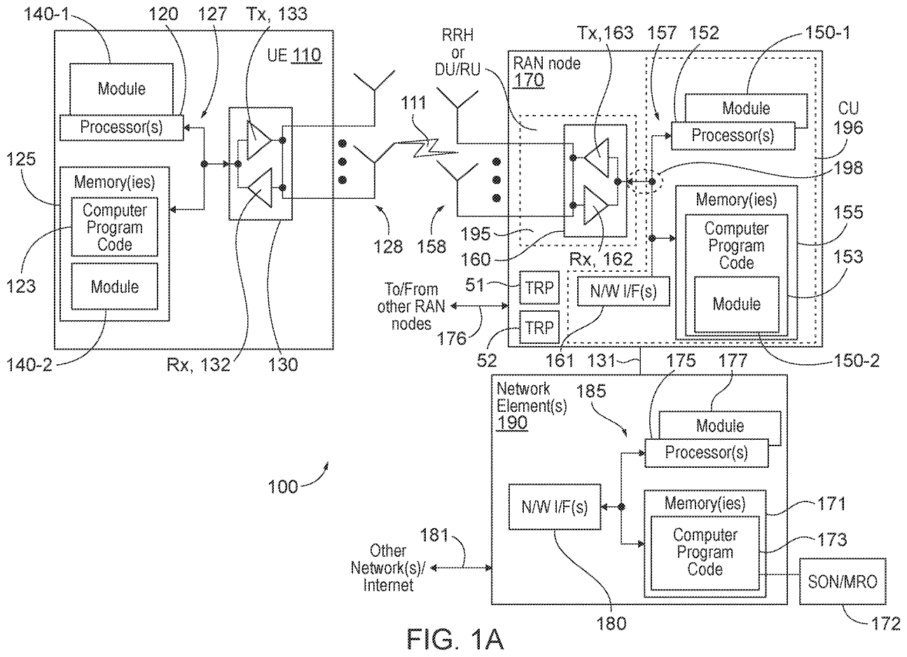

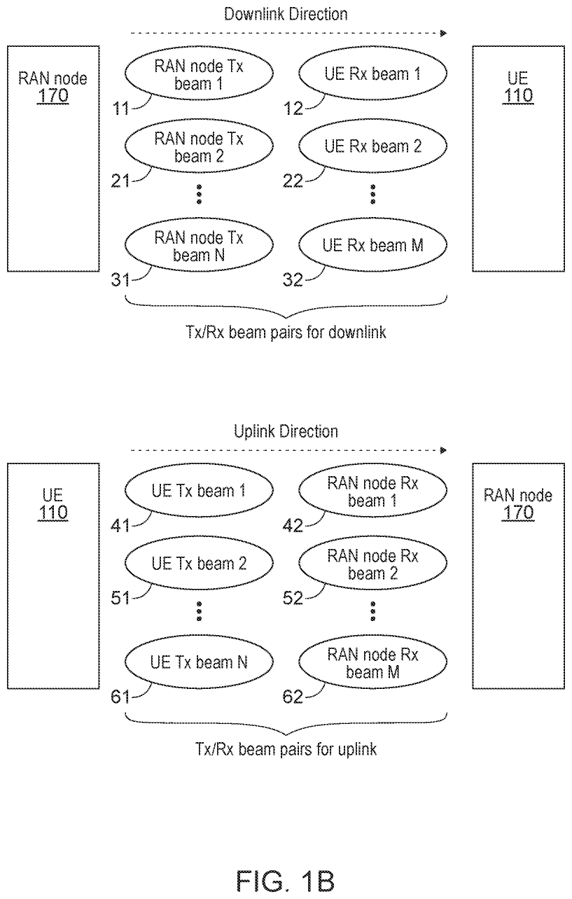

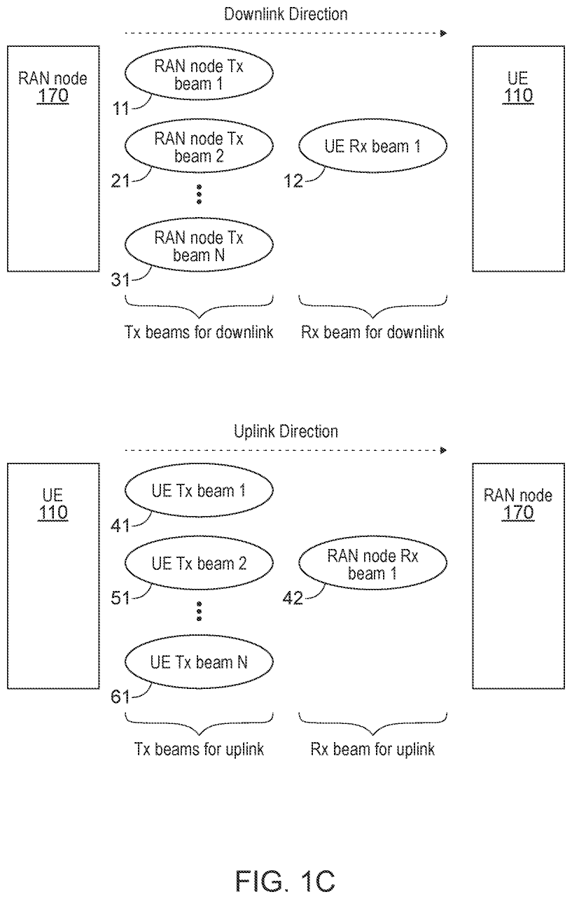

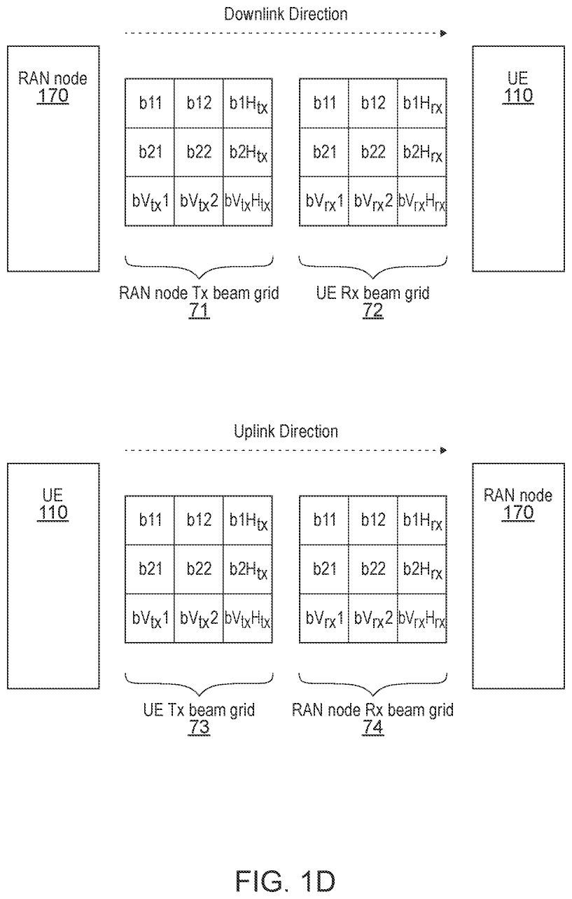

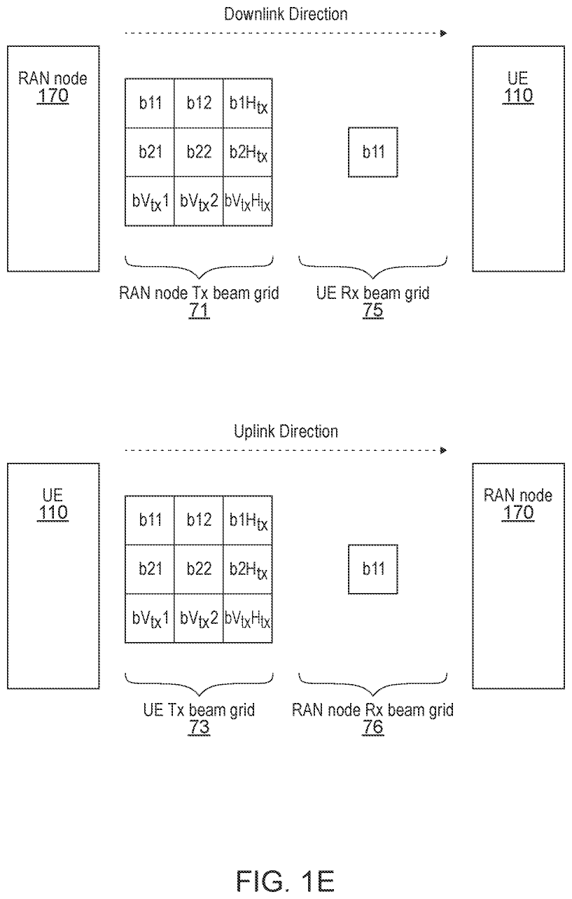

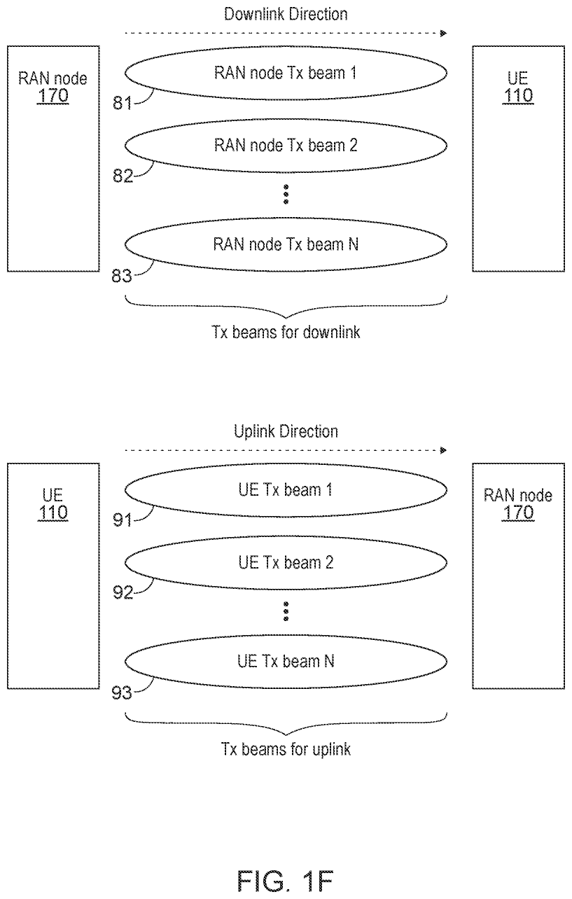

Turning to FIG. 1A, this figure shows a block diagram of one possible and non-limiting example in which the examples may be practiced. A user equipment (UE) 110, radio access network (RAN) node 170, and network element(s) 190 are illustrated. In the example of FIG. 1A, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1A shows that the RAN node 170 comprises two TRPs, TRP 51 and TRP 52. The RAN node 170 may host or comprise other TRPs not shown in FIG. 1A. The TRPs 51 and 52 may form part of the components of transceiver 160.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and both 5G and LTE functions may be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The one or more network elements 190 comprises a module 177 that may include Near-Real-Time RIC functionality. Computer program code 173 may include Near-Real-Time RIC functionality. Module 150-1 and/or module 150-2 may include Near-Real-Time RIC functionality.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including Bayesian optimization for beam tracking. Thus, computer program code 123, module 140-1, module 140-2, and other elements/features shown in FIG. 1A of UE 110 may implement user equipment related aspects of the methods described herein. Computer program code 153, module 150-1, module 150-2, and other elements/features shown in FIG. 1A of RAN node 170 may implement gNB/TRP related aspects of the methods described herein. Computer program code 173 and other elements/features shown in FIG. 1A of network element(s) 190 may be configured to implement network element related aspects of the methods described herein.

Having thus introduced a suitable but non-limiting technical context for the practice of the example embodiments, the example embodiments are now described with greater specificity.

Addressed herein is the situation where a wireless transmitter (163) with multiple antennas (158) is communicating with a wireless receiver (132) via a set of beams. A beam is specified by a vector that indicates the phase-shift applied to the signal transmitted from each antenna. Typically, the purpose of the beam vector is to direct the energy from the antennas towards the receiver. It is also common for the set of available beams to form a 2D grid. The horizontal axis of the grid is referred to as the azimuth direction, and the vertical axis of the grid is referred to as the elevation direction.

At each time instant the system should choose the beam that provides the best receive power at the receiver (132). In the case that the transmission is line-of-sight, the beam should point directly at the receiver. In more complex channel environments, the best beam could be a more complicated function of the system geometry.

An assumption made herein is that any beam can be measured at any time instant by transmitting a reference signal which can be measured at the receiver (132). One simple solution is to measure every beam at every time instance. However, this is prohibitively expensive in terms of time and communication overhead. An alternative is to measure the received power at only a subset of the beams and use this information to decide which beams should be measured at subsequent time steps. The goal of the examples described herein is to pick a set of beams to measure at each time step and then pick a beam used for sending information from the transmitter (163) to the receiver (132), and in some examples for sending information from the transmitter (133) to the receiver (162).

In 3GPP Rel-18 SI scope (RP-213599), the beam prediction in time and/or spatial domain has been identified as a potential use case to apply AI/ML to assist wireless communications systems for saving overhead and latency reduction. An initial set of use cases includes beam management, e.g., beam prediction in time, and/or spatial domain for overhead and latency reduction, and beam selection accuracy improvement [RAN1].

Temporal beam tracking refers to the broad range of ML approaches that optimizes beam(s) to use for the following one (or more time) instance(s) based on previous RSRP measurements.

Thus, the wireless system as described herein comprises a transmitter (163) and a receiver (132). A discrete set of beam vectors is associated with the transmitter. Similarly, a discrete set of beam vectors is associated with the receiver. Time is divided into time steps. At each time step, the goal is to select a transmit beam at the transmitter (163, 133), and a receive beam at the receiver (162, 132), so as to maximize the RSRP (received power) of the transmitted signal at the receiver (162, 132).

There are correlations in both time and space. If two transmit beams are close to each other in the grid, the resulting RSRP for those two beams is correlated. Similarly, since a mobile device can only move a limited amount between any two consecutive time steps, the RSRP for a given beam pair is correlated for adjacent time steps. This means that, even if every beam pair cannot be measured at every time step, the previous RSRP measurements can be used to approximate the received power for beam pairs that are not able to be measured.

The spatial beam-tracking problem involves the system performing the following at each time step: i) pick a set B[i] of transmit/receive beam pairs on which to measure the received power out of the overall set of beams [symbol] , and ii) pick a single transmit/receive beam pair out of the set of available beams on which to transmit data. The transmit/receive beam pair used for data transmission may or may not be among the beam pairs within the set B[i] for which RSRP is measured. The quality of the solution provided by the examples described herein is determined by the received power on the beam pair ultimately selected for the data transmission. In an alternative embodiment, the quality of the solution provided by the examples described herein is determined by the received power on the reception (Rx) beam corresponding to a transmission (Tx) beam ultimately selected for the data transmission.

Referring to FIG. 1B, in the downlink direction there are N Tx beams (N being an integer) and M Rx beams (M being an integer), where beam 11 is RAN node Tx beam 1, beam 12 is UE Rx beam 1, beam 21 is RAN node Tx beam 2, beam 22 is UE Rx beam 2, beam 31 is RAN node Tx beam N, and beam 32 is UE Rx beam M. There are N×M beam pairs. When N is 3 and M is 3 there are nine (9) beam pairs, including (11, 12), (11, 22), (11, 32), (21, 12), (21, 22), (21, 32), (31, 12), (31, 22), (31, 32). The beams (e.g. beam pairs) in the downlink direction are such that when the RAN node 170 transmits data or a signal on one of the Tx beams (one of 11, 21, 31), the UE 110 receives the data or the signal on one of the Rx beams (one of 12, 22, 32).

In an embodiment based on FIG. 1B, a subset B[i] of the N beam pairs in the downlink direction is determined, based on the examples described herein. The RSRP is measured for the tx/rx beam pairs in B[i], such that the RSRP on the rx beam is measured for the given beam pair. For example, the RSRP is measured for beam pair (11, 12) and for beam pair (21, 22), where the beam pairs (11, 12) and (21, 22) are in B[i], while the RSRP for the other beam pairs is not measured. An inference is generated for the N×M beam pairs in the downlink direction, the inference generating an RSRP probability distribution for the N×M beam pairs. Using the inference and other aspects of the examples described herein, ultimately one of the beams (e.g. one of beam pairs (11, 12), (11, 22), (11, 32), (21, 12), (21, 22), (21, 32), (31, 12), (31, 22), (31, 32)) is selected for data transmission in the downlink direction from RAN node 170 to UE 110.

Referring to FIG. 1B, in the uplink direction there are N Tx beams (N being an integer) and M Rx beams, where beam 41 is UE Tx beam 1, beam 42 is RAN node Rx beam 1, beam 51 is UE Tx beam 2, beam 52 is RAN node Rx beam 2, beam 61 is UE Tx beam N, and beam 62 is RAN node Rx beam M. There are N×M beam pairs. When N is 3 and M is 3 there are nine (9) beam pairs, including (41, 42), (41, 52), (41, 62), (51, 42), (51, 52), (51, 62), (61, 42), (61, 52), (61, 62). The beams (e.g. beam pairs) in the uplink direction are such that when UE 110 transmits data or a signal on one of the Tx beams (one of 41, 51, 61), the RAN node 170 receives the data or the signal on one of the Rx beams (one of 42, 52, 62).

In an embodiment based on FIG. 1B, a subset B[i] of the N beam pairs in the uplink direction is determined, based on the examples described herein. The RSRP is measured for the tx/rx beam pairs in B[i], such that the RSRP on the rx beam is measured for the given beam pair. For example, the RSRP is measured for beam pair (41, 42) and for beam pair (51, 52), where the beam pairs (41, 42) and (51, 52) are in B[i], while the RSRP for the other beam pairs is not measured. An inference is generated for the N×M beam pairs in the uplink direction, the inference generating an RSRP probability distribution for the N×M beam pairs. Using the inference and other aspects of the examples described herein, ultimately one of the beams (e.g. one of beam pairs (41, 42), (41, 52), (41, 62), (51, 42), (51, 52), (51, 62), (61, 42), (61, 52), (61, 62)) is selected for data transmission in the uplink direction from UE 110 to RAN node 170.

FIG. 1B separates the beams used in the downlink direction and uplink direction for ease of description, however the beams (e.g. beam pairs) used for downlink can be the beams used for uplink. For example, one or more of the RAN node Tx beams (11, 21, 31) may be used as one or more of the RAN node Rx beams (42, 52, 62) and one or more of the UE Rx beams (12, 22, 32) may be used as one or more of the UE node Tx beams (41, 51, 61).

FIG. 1C shows a case of FIG. 1B, where there is one Rx beam under consideration (M=1).

Referring to FIG. 1C, in the downlink direction there are N Tx beams (N being an integer) and one Rx beam, where beam 11 is RAN node Tx beam 1, beam 21 is RAN node Tx beam 2, beam 31 is RAN node Tx beam N, and beam 12 is UE Rx beam 1. From these beams there are three (3) beam pairs, including (11, 12), (21, 12), and (31, 12). The beams (e.g. beam pairs) in the downlink direction are such that when the RAN node 170 transmits data or a signal on one of the Tx beams (one of 11, 21, 31), the UE 110 receives the data or the signal on Rx beam 1 12.

In an embodiment based on FIG. 1C, a subset B[i] of the N Tx beams in the downlink direction is determined, based on the examples described herein. The RSRP is measured for the tx beams in B[i], namely the RSRP on UE Rx beam 1 12 that receives a signal transmitted on one of the tx beams (one of 11, 21, 31). For example, the RSRP is measured based on transmission from Tx beams 11 and 21, where the beams 11 and 21 are in B[i], while Tx beam 31 is not in B[i] so that an RSRP of the reception beam 12 that receives a signal from Tx beam 31 is not measured. An inference is generated for the N beams in the downlink direction, the inference generating an RSRP probability distribution for the N Tx beams (the likelihood of the RSRP on the beam 12 receiving a signal transmitted from one of the N Tx beams). Using the inference and other aspects of the examples described herein, ultimately one of the beams (e.g. one of the Tx beams (11), (21), or (31)) is selected for data transmission in the downlink direction from the RAN node 170 to the UE 110, among the Tx beams of the RAN node 170.

Referring to FIG. 1C, in the uplink direction there are N Tx beams (N being an integer) and one Rx beam, where beam 41 is UE Tx beam 1, beam 51 is UE Tx beam 2, beam 61 is UE Tx beam N, and beam 42 is RAN node Rx beam 1. From these beams there are three (3) beam pairs, including (41, 42), (51, 42), and (61, 42). The beams (e.g. beam pairs) in the uplink direction are such that when the UE 110 transmits data or a signal on one of the Tx beams (one of 41, 51, 61), the RAN node 170 receives the data or the signal on Rx beam 42.

In an embodiment based on FIG. 1C, a subset B [i] of the N Tx beams in the uplink direction is determined, based on the examples described herein. The RSRP is measured for the tx beams in B[i], namely the RSRP on Rx beam 42 that receives a signal transmitted on one of the tx beams (one of 41, 51, 61). For example, the RSRP is measured based on transmission from Tx beams 41 and 51, where the beams 41 and 51 are in B[i], while Tx beam 61 is not in B[i] so that an RSRP of the reception beam 42 that receives a signal from Tx beam 61 is not measured. An inference is generated for the N Tx beams in the uplink direction, the inference generating an RSRP probability distribution for the N Tx beams (the likelihood of the RSRP on beam 42 receiving the signal transmitted from one of the N Tx beams). Using the inference and other aspects of the examples described herein, ultimately one of the beams (e.g. one of the Tx beams (41), (51), or (61)) is selected for data transmission in the uplink direction from the UE 110 to the RAN node 170, among the Tx beams of the UE 110.

FIG. 1C separates the beams used in the downlink direction and uplink direction for ease of description, however the beams (e.g. beam pairs) used for downlink can be the beams used for uplink. For example, when implemented UE Rx beam 1 12 may be one of UE Tx beam 1 41, UE Tx beam 2 51, or UE Tx beam N 61, and when implemented RAN node Rx beam 1 42 may be one of RAN node Tx beam 1 11, RAN node Tx beam 2 21, or RAN node Tx beam N 31.

In FIG. 1C, the 1 Rx beam 12 for downlink is a generalization. The UE Rx beam for downlink can be any of beams 12, 22, or 32. In FIG. 1C, the 1 Rx beam 42 for uplink is a generalization. The RAN node Rx beam for uplink can be any of beams 42, 52, or 62.

Referring to FIG. 1D, in the downlink direction there are Hₜₓ×Vₓ Tx beams (Hₜₓ and Vₜₓ being integers corresponding to the horizontal and vertical lengths, respectively, of the Tx beam grid 71) and Hᵣₓ×Vᵣₓ Rx beams (Hᵣₓ and Vᵣₓ being integers corresponding to the horizontal and vertical lengths, respectively, of the Rx beam grid 72). There are Hₜₓ×Vᵣₓ×Hᵣₓ×Vᵣₓ beam pairs. For example, b11 in the Tx beam grid 71 is paired with b11 in the Rx beam grid 72. The beams (e.g. beam pairs) in the downlink direction are such that when the RAN node 170 transmits data or a signal on one of the Tx beams (e.g. b11 of Tx beam grid 71), the UE 110 receives the data or the signal on one of the Rx beams (e.g. b11 of Rx beam grid 72).

In an embodiment based on FIG. 1D, a subset B[i] of the Hₜₓ×Vₜₓ×Hᵣₓ×Vᵣₓ beam pairs in the downlink direction is determined, based on the examples described herein. The RSRP is measured for the tx/rx beam pairs in B[i], such that the RSRP on the rx beam is measured for the given beam pair. For example, the RSRP is measured for beam pair (b11 of 71, b11 of 72) and for beam pair (b11 of 71, b12 of 72), where the beam pairs (b11 of 71, b11 of 72) and (b11 of 71, b12 of 72) are in B[i], while the RSRP for the other beam pairs is not measured. An inference is generated for the Hₜₓ×Vₜₓ×Hᵣₓ×Vᵣₓ beam pairs in the downlink direction, the inference generating an RSRP probability distribution for the Hₜₓ×Vₜₓ×Hᵣₓ×Vᵣₓ beam pairs. Using the inference and other aspects of the examples described herein, ultimately one of the beams (e.g. one of beam pairs) is selected for data transmission in the downlink direction from RAN node 170 to UE 110.

Referring to FIG. 1D, in the uplink direction there are Hₜₓ×Vₓ Tx beams (Hₜₓ and Vₓ being integers corresponding to the horizontal and vertical lengths, respectively, of the Tx beam grid 73) and Hᵣₓ×Vᵣₓ Rx beams (Hᵣₓ and Vᵣₓ being integers corresponding to the horizontal and vertical lengths, respectively, of the Rx beam grid 74). There are Hₜₓ×Vₜₓ×Hᵣₓ×Vᵣₓ beam pairs. For example, b11 in the Tx beam grid 73 is paired with b11 in the Rx beam grid 74. The beams (e.g. beam pairs) in the uplink direction are such that when the UE 110 transmits data or a signal on one of the Tx beams (e.g. b11 of Tx beam grid 73), the RAN node 170 receives the data or the signal on one of the Rx beams (e.g. b11 of Rx beam grid 74).

In an embodiment based on FIG. 1D, a subset B[i] of the Hₜₓ×Vₜₓ×Hᵣₓ×Vᵣₓ beam pairs in the downlink direction is determined, based on the examples described herein. The RSRP is measured for the tx/rx beam pairs in B[i], such that the RSRP on the rx beam is measured for the given beam pair. For example, the RSRP is measured for beam pair (b11 of 73, b11 of 74) and for beam pair (b11 of 73, b12 of 74), where the beam pairs (b11 of 73, b11 of 74) and (b11 of 73, b12 of 74) are in B[i], while the RSRP for the other beam pairs is not measured. An inference is generated for the Hₜₓ×Vₜₓ×Hᵣₓ×Vᵣₓ beam pairs in the uplink direction, the inference generating an RSRP probability distribution for the Hₜₓ×Vₜₓ×Hᵣₓ×Vᵣₓ beam pairs. Using the inference and other aspects of the examples described herein, ultimately one of the beams (e.g. one of beam pairs) is selected for data transmission in the uplink direction from UE 110 to RAN node 170.

FIG. 1D separates the beams used in the downlink direction and uplink direction for ease of description, however the beams (e.g. beam pairs) used for downlink can be the beams used for uplink. For example, one or more of the RAN node Tx beams (e.g. b11 of 71) may be used as one or more of the RAN node Rx beams (e.g. b11 of 74) and one or more of the UE Rx beams (e.g. b11 of 72) may be used as one or more of the UE node Tx beams (e.g. b11 of 73).

FIG. 1E shows a case of FIG. 1D, where there is one Rx beam under consideration (Hᵣₓ=Vᵣₓ=1).

Referring to FIG. 1E, in the downlink direction there are Hₜₓ×Vₓ Tx beams (Hₜₓ and Vₜₓ being integers corresponding to the horizontal and vertical lengths, respectively, of the Tx beam grid 71) and one beam b11 in Rx beam grid 75 on the UE side. There are Hₜₓ×Vₜₓ beam pairs. For example, b11 in the Tx beam grid 71 is paired with b11 in the Rx beam grid 75. The beams (e.g. beam pairs) in the downlink direction are such that when the RAN node 170 transmits data or a signal on one of the Tx beams (e.g. b11 of Tx beam grid 71), the UE 110 receives the data or the signal on b11 of Rx beam grid 75.

In an embodiment based on FIG. 1E, a subset B[i] of the Hₜₓ×Vₜₓ beams in the downlink direction is determined, based on the examples described herein. The RSRP is measured for the tx beams in B[i], such that the RSRP on the rx beam is measured for the transmitting Tx beam. For example, the RSRP is measured for beams b11 of 71 and b12 of 71, where beams b11, b12 of grid 71 are in B[i], while the RSRP for the other beams within grid 71 is not measured. An inference is generated for the Hₜₓ×Vₜ×Tx beams of grid 71 in the downlink direction, the inference generating an RSRP probability distribution for the Hₜₓ×Vₜₓ Tx beams of grid 71. Using the inference and other aspects of the examples described herein, ultimately one of the Tx beams of the grid 71 is selected for data transmission in the downlink direction from RAN node 170 to UE 110.

Referring to FIG. 1E, in the uplink direction there are Hₜₓ×Vₜₓ Tx beams (Hᵣₓ and Vᵣₓ being integers corresponding to the horizontal and vertical lengths, respectively, of the Tx beam grid 73) and one beam b11 in Rx beam grid 76 on the RAN node side. There are Hₜₓ×Vₜₓ beam pairs. For example, b11 in the Tx beam grid 73 is paired with b11 in the Rx beam grid 76. The beams (e.g. beam pairs) in the uplink direction are such that when the UE 110 transmits data or a signal on one of the Tx beams (e.g. b11 of Tx beam grid 73), the RAN node 170 receives the data or the signal on b11 of Rx beam grid 76.

In an embodiment based on FIG. 1E, a subset B[i] of the Hₜₓ×Vₜₓ beams in the uplink direction is determined, based on the examples described herein. The RSRP is measured for the tx beams in B[i], such that the RSRP on the rx beam is measured for the transmitting Tx beam. For example, the RSRP is measured for beams b11 of 73 and b12 of 73, where beams b11, b12 of grid 73 are in B[i], while the RSRP for the other beams within grid 73 is not measured. An inference is generated for the Hₜₓ×Vₜₓ Tx beams of grid 73 in the uplink direction, the inference generating an RSRP probability distribution for the Hₜₓ×Vₜₓ Tx beams of grid 73. Using the inference and other aspects of the examples described herein, ultimately one of the Tx beams of the grid 73 is selected for data transmission in the uplink direction from UE 110 to RAN node 170.

FIG. 1E separates the beams used in the downlink direction and uplink direction for ease of description, however the beams (e.g. beam pairs) used for downlink can be the beams used for uplink. For example, one or more of the RAN node Tx beams (e.g. b11 of 71) may be used as the RAN node Rx beam (b11 of 76) and the UE Rx beam (b11 of 75) may be used as one or more of the UE node Tx beams (e.g. b11 of 73).

In FIG. 1E, the 1 Rx beam b11 of 75 for downlink is a generalization. For example, the UE Rx beam for downlink can be any of beams within grid 72. In FIG. 1E, the 1 Rx beam b11 of grid 76 for uplink is a generalization. For example, the RAN node Rx beam for uplink can be any of beams within grid 74.

In FIG. 1D and FIG. 1E, grid 71 may correspond to one or more antennas, grid 72 may correspond to one or more antennas, grid 73 may correspond to one or more antennas, grid 74 may correspond to one or more antennas, grid 75 may correspond to one or more antennas, and grid 76 may correspond to one or more antennas.

FIG. 1F shows N Tx beams for downlink (81, 82, . . . , 83) and N Tx beams for uplink (91, 92, . . . , 93). With this configuration, the problem is similar to that shown in FIG. 1C and FIG. 1E. One of the beams (one of 81, 82, . . . , 83, and one of 91, 92, . . . , 93) is ultimately selected for transmission based on an RSRP probability distribution generated for those beams compared to a subset of those beams for which RSRP is measured.

As used herein, the set B [i] may refer to a selected set of beam pairs (e.g. Tx/Rx beam pairs, and in this case a beam pair may be referred to as a beam), or the set B[i] may refer to a selected set of beams (e.g. Tx beams). As used herein, when an RSRP is determined for a beam, this may mean determining RSRP for a Tx/Rx beam pair, or this may mean determining RSRP for a Tx beam (where e.g. the RSRP corresponds to the receive power of the receiving Rx beam when using the Tx beam).

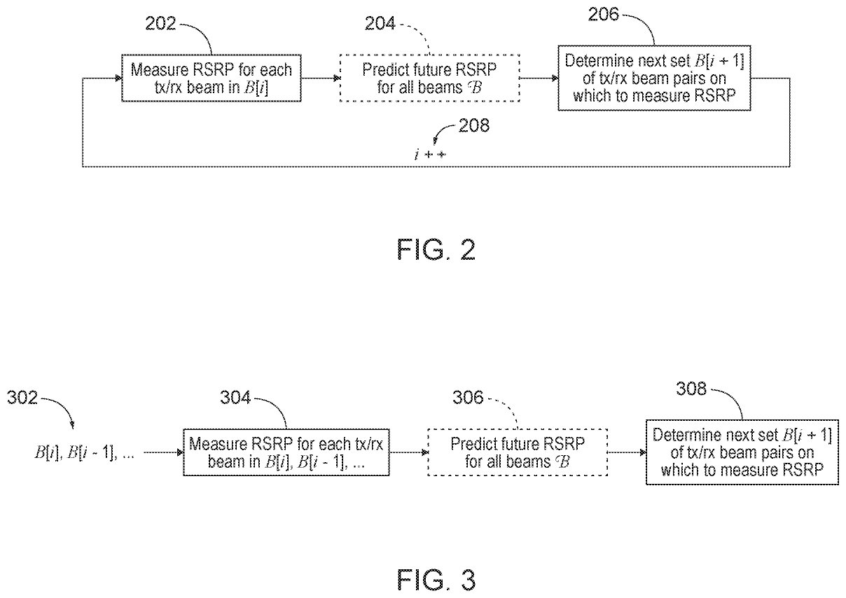

The spatial beam-tracking problem may be referred to as spatial/closed-loop beam-tracking since the choice of the beams at any time is made on the basis of RSRP measurements performed in the past, in a closed-loop fashion, as illustrated in FIG. 2.

Referring to FIG. 2, at 202, the RSRP is measured for each tx/rx beam in B[i]. At 204, the future RSRP is predicted for all beams [symbol] . At 206, the method includes determining a next set B[i+1] of tx/rx beam pairs on which to measure the RSRP. From item 206, the method transitions back to item 202 during which at 208 i is incremented by one as i++.

On the other hand, the temporal/one-shot beam prediction problem, which can be seen as a sub-routine of the case described herein, predicts beam RSRP for subsequent time steps given previous RSRP measurements, without any feedback loop, as illustrated in FIG. 3.

Referring to FIG. 3, at 302, sets of beams B [i], B[i−1], . . . are given. At 304, the method includes measuring RSRP for each tx/rx beam in B[i], B[i−1], . . . . At 306, the method includes predicting the future RSRP for all beams [symbol] . At 308, the method includes determining a next set B [i+1] of tx/rx beam pairs on which to measure the RSRP.

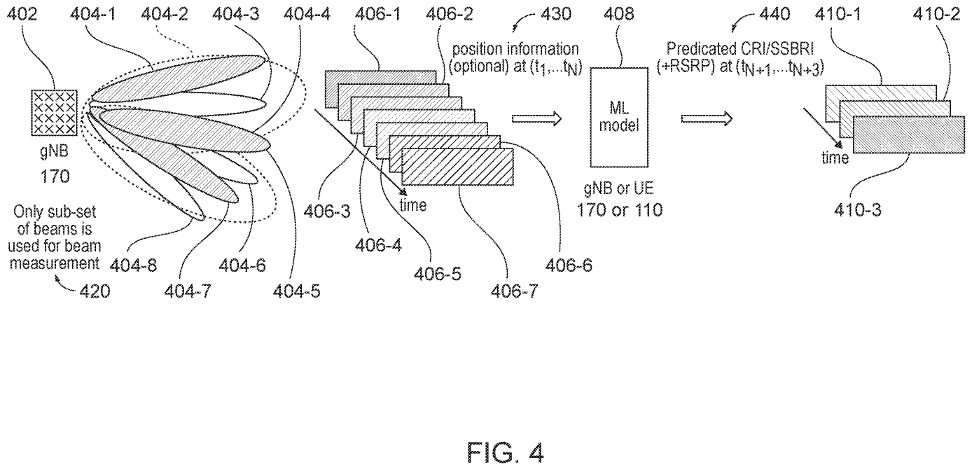

An example scenario of the problem is shown in FIG. 4, where a subset of the past and current beam measurements may be used to predict the ranking of the best beam for the following one or more time instances, thus reduce the signaling overhead for the beam measurements in the following one or more time instances.

FIG. 4 shows gNB 170 having a grid-of-beams 402. Only a subset of beams is used for beam measurement (420). For example, of beams 404-1, 404-2, 404-3, 404-4, 404-5, 404-6, 404-7, 404-8 within the grid-of-beams 402, beams 404-1, 404-4, and 404-6 are used for beam measurement. A collection of measured RSRP and position information at various time instances is shown, including RSRP and position information 406-1, 406-2, 406-3, 406-4, 406-5, 406-6, and 406-N, which at 430 are provided as input to ML model 408, which ML model 408 is a part of gNB 170 or UE 110. At 440, the ML model 408 generates predicted CRI/SSBRI and RSRP at various time instances, where predictions (410-1, 410-2, 410-3) are for time instances t_{N+1}, t_{N+2}, . . . , t_{N+3}.

The overarching goal is to achieve an optimal trade-off between signal strength and UE reporting overhead. Signal strength is for example the RSRP of the beam pair that is actually used at each time slot for transmission (i.e., the beams with highest RSRP among those proposed in B[i]). Regarding UE reporting overhead, the higher the number of beams on which UE has to report RSRP measurements to the gNB (i.e., |B[i]I), the higher the overhead that UE has to incur.

On the other hand, the method described herein involves “spatial”/closed-loop beam tracking described in FIG. 2. The examples described herein do not prescribe how to decide the identity of the next beams to be deployed as a function of the RSRP measured on the previous set of beams. Hence, the examples described herein do not fall strictly into the “temporal”/open-loop beam prediction scenario described in FIG. 3. On the other hand, the examples described herein relate to “spatial”/closed-loop beam tracking described in FIG. 2. The examples described herein assume that UEs report RSRP for used beams (such reporting being standardized), and do not make any specific assumption on the channel, while fitting a Gaussian Process to the RSRP as a function of beam indexes and time, by learning optimal hyper-parameters of an inference model on the fly. The herein described approach does not require training the model, and works well since UE 110 first connects to the network 100 and only requires UE 110 to report RSRP for each used beam, as in the current standards.

Assumptions and terminology. In the following it is generally assumed that data is being transmitted in the downlink direction from a gNB 170 to a UE 110. Hence the gNB is the transmitter and the UE is the receiver. It is assumed that the gNB has a rectangular antenna with Nh horizontal antennas and Nᵥ vertical antennas. As an example, the gNB could use a set of 2D DFT (Discrete Fourier Transform) beams defined by a discrete set of angles. [symbol] is the total set of available DFT beams.

A focus herein is on the beam choice at the gNB side in the downlink direction, with a corresponding Rx beam on the UE side in the downlink direction. One problem is related to choice of the Tx beam when there is one Rx beam under consideration (M=1 in FIG. 1B, or FIG. 1C, or H, =Vᵣₓ=1 in FIG. 1D, or FIG. 1E), while another problem is choice of a Tx beam with multiple Rx beams under consideration (M>1 in FIG. 1B, or Hᵣₓ or Vᵣₓ of grid 72>1 in FIG. 1D, or H, or V, of grid 74>1 in FIG. 1D). These two problems are considered separately herein, but the methods and examples described herein are applicable to both problems. For beam choice at the gNB side, it is assumed that the UE scans through its own beams and, for each gNB's b_{h,v}, reports the best RSRP. Then, for a given UE, RSRP_{h,v}[i] is the RSRP measured by the UE at time slot i when beam b_{h,v} is used by the gNB. To clarify notation, for example, when b11 of grid 71 is used by the gNB, then the gNB uses b_{1,1}, and when b12 of grid 71 is used by the gNB, then the gNB uses b_{1,2}, etc.

Goal. Fixing a UE. Let B[i]⊂B be the set of DFT beams (or beam pairs) selected by gNB at time slot i for the specific UE. The goal is to maximize the RSRP measured by the UE while limiting the number of selected beams to reduce reporting overhead:

$$max {\sum }_{i \geq 0} {RSRP}_{B [ i ]} [ i ] , while keeping \vert B [ i ] \vert “ small ” ∀ i$$

where

$${RSRP}_{B [ i ]} [ i ] := {max}_{{b}_{h , v} ∈ B [ i ]} {RSRP}_{h , v} [ i ]$$

is the highest RSRP measured by the UE at time i when gNB has selected beams B[i]. Indeed, the gNB uses the beam with highest measured RSRP for data transmission with the UE. The herein described method is UE-specific. The UE identity remains implicit if not mentioned.

Main steps. Assume that at time i=0 a new UE 110 connects to gNB 170.

1. RSRP inference model initialization. The gNB exploits historical RSRP data collected for different UEs to initialize the RSRP inference engine, and more specifically the prior mean and the kernel hyper-parameters of a Gaussian Process (GP).

Then, at time slots i=0,1, . . . perform steps 2 through 5 below.

2. RSRP inference modelfit. The gNB maintains a running inference of the RSRP for each DFT beam via a Gaussian Process (GP) and updates it given previous RSRP measurements reported by the UE. The GP is characterized by hyper-parameters θ.

3. Beam set selection. Based on the Gaussian Process inference in step 2, the gNB selects for transmission a minimal set B[i] of DFT beams maximizing the expected improvement of the RSRP.

4. RSRP reporting. For each narrow beam b_{h,v} in B[i], UE scans through its beams and sends to the gNB the best RSRP measured, referred to as RSRP_{h,v}[i], as implemented in current standards.

5. RSRP inference model update. The gNB updates the hyperparameters θ by maximizing the likelihood of the past RSRP measurements. Step 5 can be performed at lower frequency, i.e., not necessarily at every slot i.

The effect of step 2 is typically to concentrate some measurements on the beam pairs that gNB 170 believes to have high RSRP. The remaining measurements are spread out more randomly to improve the estimates of beams that have not been measured recently.

The main advantages and technical effects of the method described herein are i) reduced overhead compared to legacy methods, which legacy methods require the gNB and UE to periodically scan through a possibly long list of beams, and ii) high RSRP performance, since beams are optimized on a per-UE basis. The examples described herein may be subject to standardization.

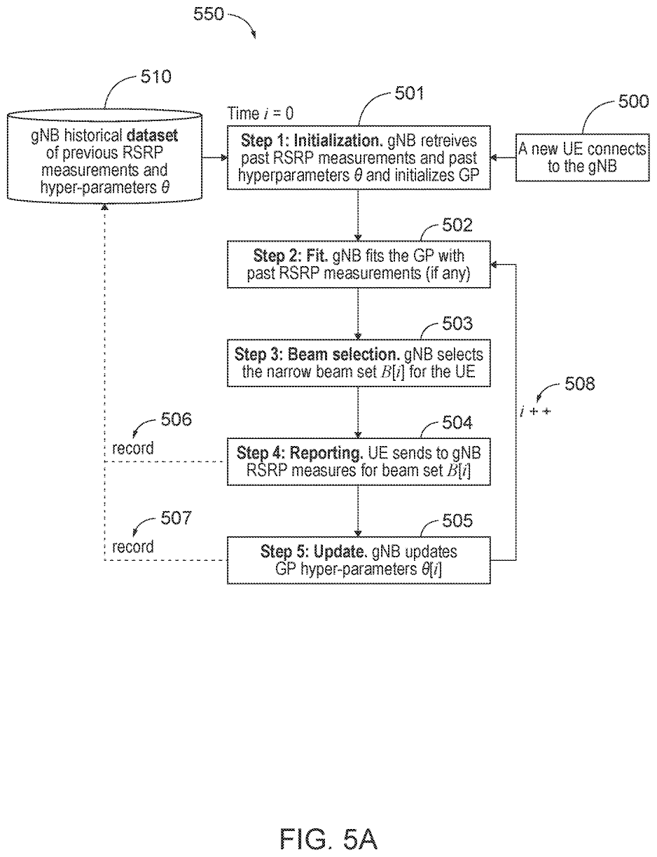

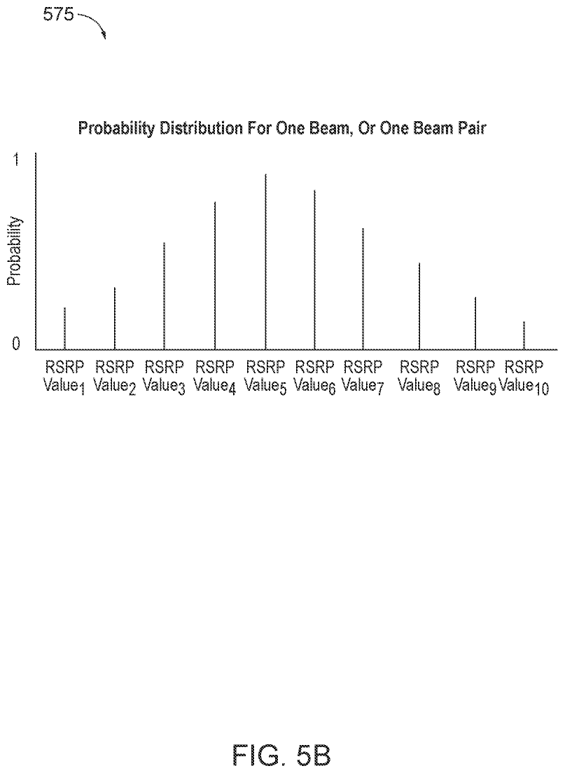

FIG. 5A shows an overview 550 of the herein described method. The method includes use of a gNB historical dataset 510 of previous RSRP measurements and hyperparameters θ. At 500 at time i=0, a new UE 110 connects to the gNB 170. During initialization (501) at time i=0, the gNB 170 retrieves from dataset 510 past RSRP measurements and past hyperparameters and initializes the Gaussian process (GP).

At 502, the gNB 170 fits the GP with past RSRP measurements (if any). The most recent measurement for a given inference could be earlier in the same slot that the inference is being made. In other words, the inference in slot i can be done using measurements in slots i−3, i−2, i−1, i. The inference creates a probability distribution for each beam (from which a most likely RSRP is able to be determined). Calculation of a probability is part of the inference model, the probability being the probability of a beam having a reference signal received power, given past reference signal received power measurements.

The inference made during step 2 creates a probability distribution for the beams within the dictionary. An example probability distribution for one beam, or one beam pair (575) is shown in FIG. 5B. The distribution provides the likelihood, as a probability between 0 and 1, of the beam (or beam pair) having one of the 10 RSRP values.

At 503, the gNB 170 selects a narrow beam set B[i] for the UE 110, where narrow is a term referring to the size of the selected beam set. For example, the gNB 170 may select the narrow beam set B[i] for the UE 110 based on an expected improvement to the RSRP for a beam. Such expected improvement is a design choice in the algorithm. This transmission B[i] refers to the set of beams that are measured (by transmitting a reference signal on those beams). Ultimately, after the inference, a single best beam is picked for the actual data transmission.

At 504, the UE 110 sends to gNB 170 RSRP measures for beam set B[i]. The method at 504 refers to performing the RSRP measurement for a single transmit beam from the base station (e.g. RAN node 170). However, the UE 110 has its own set of receive beams, and the UE measures the RSRP for the transmit beam by trying all its beams on the receive side and reporting the best value.

At 505, the gNB 170 updates GP hyperparameters θ[i]. During the update at 505, the goal is to choose a θ that maximizes the probability that the inferred RSRP for a measured beam—right before the measurement is done—is actually equal to the measured value. Therefore, the goal is to maximize the probability that the inferences are correct, for the beam/time pairs that are actually measured.

The method transitions from 505 to 502, during which time, at 508, time is incremented (i++). Optionally at 506, the RSRP measures reported at 504 are recorded within historical dataset 510, and optionally at 507, the GP hyperparameters updated at 505 are recorded within historical dataset 510.

Described next in further detail are the enumerated steps as illustrated in FIG. 5A.

For clarity of exposition described are steps 2 (502), 3 (503), 5 (505), and finally step 1 (501). Step 4 may be implemented leveraging standardization.

Step 2: RSRP inference model fit. The gNB 170 maintains a running estimate/belief of the RSRP for each DFT beam via a Gaussian Process (GP) and updates it given previous RSRP measurements provided by the UE.

Formally speaking, a GP is a collection of random variables, such that any finite collection of those random variables is jointly Gaussian. In this case, RSRP_{h,v}[i](i.e., the RSRP measured by the UE at time i when DFT beam b_{h,v} is used by gNB) is modeled as a realization of a GP in the 3 independent variables u, v, i.

GP formalism is convenient to infer the RSRP for any beam b_{h,v} at the next time step i given previous RSRP observations

$${\{ {RSRP}_{h , v} [ k ] \}}_{{b}_{h , v} ∈ B [ k ] k < i}$$

via the classic Gaussian posterior formula. To this aim defined are:
a) the GP covariance between any two pairs RSRP_{h,v}[i] and RSRP_{h′,v′}[i′]
b) the GP (prior) mean of RSRP_{h,v}[i] for (ideally) all h, v, i

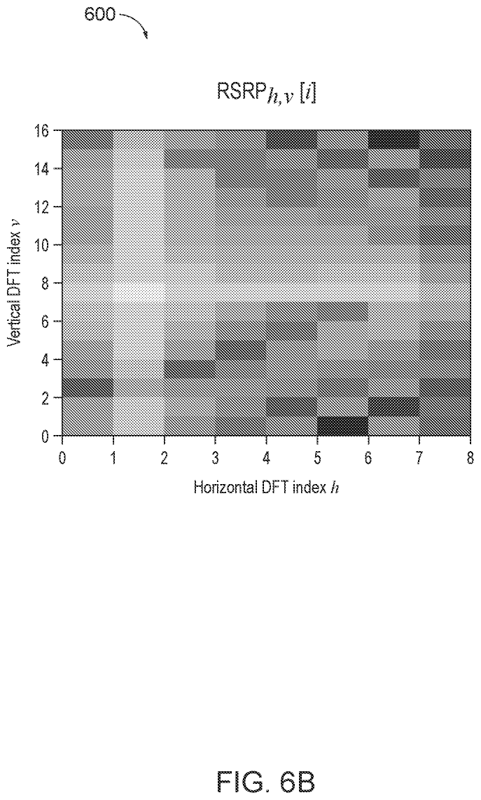

Covariance. The covariance between any two pairs RSRP_{h,v}[i] and RSRP_{h,v}[i] is defined as the sum K((h, v, i), (h′, v′, i′))+σ²δ_{(h,v,i),(h′,v′,i′)}, where K is a so-called kernel function and δ=1 if (h, v, i)=(h′, v′, i′) and 0 otherwise. Therefore,
K measures how similar RSRP_{h,v}[i] and RSRP_{h′,v′}[i′] are expected to be
σ² describes the noise power of RSRP measurements.
   The kernel function is naturally defined as a decreasing function of the points (h, v, i), (h′, v′, i′), where the closer (h, v, i), (h′, v′, i′), the more similar RSRP_{h,v}[i] and RSRP_{h′,v′}[i′] are expected to be (FIG. 6, item 600).

For convenience the kernel function is decoupled as the product of two kernels:

$$K ( ( h , v , i ) , ( {h}^{′} , {v}^{′} , {i}^{′} ) ) := {K}_{space} ( ( h , v ) , ( {h}^{′} , {v}^{′} ) ) \times {K}_{time} ( i , {i}^{′} )$$

where K_{space}((h, v), (h′, v′)) accounts for the similarity of RSRP across different beams at any time instant while Kₜᵢₘₑ (i, i′) describes how quickly the RSRP of any beam evolves over time, which depends on the UE mobility pattern and the dynamics of the scattering environment.

A possible choice for the two kernels is a radial basis function (RBF) which decays exponentially fast with the distance between two beam indexes (for spatial kernel) or time instants (for temporal kernel):

$${K}_{space} ( ( h , v ) , ( {h}^{′} , {v}^{′} ) ) = {a}_{space} {e}^{- \frac{( {( h - {h}^{′} )}^{2} + {( v - {v}^{′} )}^{2} )}{{b}_{space}}}$$

$${K}_{time} ( i , {i}^{′} ) = {a}_{time} {e}^{- \frac{{( i - {i}^{′} )}^{2}}{{b}_{time}}}$$

Another possible option for space kernel is the Matérn kernel. The parameters a_{space}, b_{space}, aₜᵢₘₑ, bₜᵢₘₑ are referred to as hyper-parameters and are denoted by θ. Step 3 relates to how to learn them in online fashion and on a per-UE basis.

Prior mean. Prior mean m is ideally defined for all (h, v, i) and describes how good RSRP_{h,v}[i] is expected to be. It is initialized as in step 1. The description of step 1 is deferred until later in this description.

GP inference. Shown now is how the gNB infers RSRP for DFT beams at the next time slot. At time slot i the gNB has collected from the specific UE the measurements

$${y}_{past} := {\{ {RSRP}_{h , v} [ k ] \}}_{{b}_{h , v} ∈ B [ k ] k < i}$$

Then thanks to the GP property for which any collection of measurements can be considered as jointly Gaussian, inferred is the distribution of the RSRP of any beam b_{u,v} at the subsequent time step i via the classic Gaussian posterior formula:

$$Pr ( {RSRP}_{h , v} [ i ] \vert {y}_{past} ) = 𝒩 ( \text{} m ( h , v , i ) + {C}_{current , past} {C}_{past}^{- 1} ( {y}_{past} - {m}_{past} ) , {σ}^{2} - {C}_{current , past} {C}_{past}^{- 1} {C}_{current , past}^{T} )$$

where
[symbol] (M, C) is a multi-variate gaussian with mean vector M and covariance matrix C
C_{current,past} is the covariance vector between past measurements and beam of interest (h, v) at next time i computed via a kernel function
Cₚₐₛₜ is the covariance matrix across all past measurements, still computed via a kernel function
mₚₐₛₜ is the prior mean in correspondence of past RSRP measurements
T is a transpose operation
−1 is a matrix inversion operation.

Step 3: Beam set selection. Based on the Gaussian Process inference in step 2, the gNB selects for transmission the beam set B[i]. Described now is how B[i] is computed via a Bayesian optimization technique.

For step 2 it was described how to infer the RSRP of any DFT beam b_{h,v}, at the next time step given past RSRP measurements reported by the UE, via Pr(RSRP_{h,v}[i]yₚₐₛₜ). Then, on the ground of such inference, gNB computes the next set of DFT beams B[i]⊂ [symbol] guaranteeing the highest RSRP_{B}[i].

The gNB faces a dilemma between exploration and exploitation. On the one hand, it is convenient to keep selecting beams that have guaranteed high RSRP in past slots (i.e., exploitation). On the other hand, it is wise to select beams that have never or seldom been deployed in the past for the specific UE to assess their quality (exploration). Moreover, UE moves, and scatterers do too, hence the identity of the best beam for the UE can change over time.

To resolve this dilemma, the gNB seeks for the set of beams the beams that maximize the expected improvement (EI) of the RSRP with respect to the highest RSRP possibly achievable at time i, which in this case writes:

$${EI}_{B} [ i ] := {𝔼 [ {RSRP}_{B} [ i ] - {RSRP}^{*} ]}^{+}$$

where

$${RSRP}_{B} [ i ] := {max}_{{b}_{h , v} ∈ B} {RSRP}_{h , v} [ i ]$$

is the highest RSRP achievable by the UE when beam set B is selected by the gNB. [symbol] is the expectation with respect to the posterior distribution of the Gaussian process (after observing RSI measurements, RSRP* is the (inferred) RSRP of the (inferred) best beam, + refers to the positive part; [3]⁺=3 while [−3]+=0. In general, [x]⁺=max (x, 0).

The choice of the optimal beamset B[i] at time i should also take into account that the number of beams in B[i] should not be too large, since this would incur high reporting overhead for the UE. Therefore, the optimal set of beams B[i] can be computed in two possible ways by the gNB, herein referred to as option 3.1 and option 3.2.

Option 3.1: Fixed beam set size. The number of beams N is here chosen in advance, and “small”. Then, B[i] maximizes the expected improvement EI_{B}:

$$B [ i ] = {arg max}_{B : B ⊂ ℬ and \vert B \vert = N} {EI}_{B} [ i ]$$

Option 3.2: Optimized beam set size. The number of beams N[i] is here automatically optimized so as to strike an optimal trade-off between expected RSRP improvement and reporting overhead caused by large beam sets, described by an affine function g(|B|) of the number of used beams |B|:

$$B [ i ] = {arg max}_{B : B ⊂ ℬ and \underline{N} \leq \vert B \vert = \overline{N}} {EI}_{B} [ i ] - g ( \vert B \vert )$$

Here, N, N̅ are a lower and upper limit on the size of the beam set.

Low complexity solution with theoretical guarantees. Both option 3.1 and option 3.2 involve solving the combinatorial problem

$$B [ i ] = {max}_{B : B ⊂ ℬ and \vert B \vert = N} {EI}_{B} [ i ] . \qquad ( 1 )$$

Indeed, (1) solves option 3.1 directly. On the other hand, option 3.2 includes solving equation (1) for all N=N, . . . N̅ and then choosing the N and corresponding B[i]: |B[i]|=N maximizing the objective EI_{B}[i]−g(|B|).

Solving equation (1) by exhaustive search is inadmissible, since the total number of DFT beams is generally higher than 100 and N̅ can go up to ~10 (100 choose 10≈1e13). Fortunately, it can be proven (the proof is omitted herein) that the function EI_{B}[i]: B→ [symbol] is monotone and submodular. [symbol] is the set of positive (non-negative) real numbers.

Therefore, the classic result, with use of mathematical programming involving e.g. an approximation for maximizing a submodular set function, can be used to claim that the following simple greedy algorithm (for at least option 3.1) has a proven optimality gap of 1/e (≈37%) meaning that the beamset produced by the greedy algorithm below (at least for option 3.1) cannot be worse than 37% of the highest expected RSRP improvement—and in practice the expected RSRP improvement is well above the lower bound.

Greedy algorithm for option 3.1:

| | |
|---|---|
| a) | Start with empty beamset B[i] = Ø |
| b) | Add to B[i] the beam b̅ = argmax_{b:b∉B[i]}EI_{B[i]∪b}[i] − EI_{B[i]}[i] |
| c) | Go back to step a) as long as \|B[i]\| < N. |
| d) | Return B[i] |

Greedy algorithm for option 3.2:

Set threshold ∈ > 0

| | |
|---|---|
| a) | Start with empty beamset B[i] = Ø |
| b) | Compute maximum increment a = max_{b:b∉B[i]}EI_{B[i]∪b}[i] − |
| | EI_{B[i]}[i] and the corresponding beam b̅ = |
| | argmax_{b:b∉B[i]}EI_{B[i]∪b}[i] − EI_{B[i]}[i] |
| c) | If a < ∈ and \|B[i]\| ≥ N then go to step e). Else, add beam b̅ to |
| | B[i] and go to step d) |
| d) | Go back to step a) if \|B[i]\| < N̅. Else, go to step e) |
| e) | Return B[i] |

In practice, EI_{B}[i] can be estimated by Monte-Carlo methods by sampling from the GP posterior distribution computed in step 1, for any beam set B.

Step 5: RSRP inference model update. As mentioned in step 1, the kernel K, determining the smoothness of the unknown RSRP meant as a function of beam indexes (h, v) and time i, depends on a few hyperparameters θ. A good choice of θ impacts the performance of the algorithm, but good values of 0 are generally not known a priori. However, θ can be tuned in online fashion, as long as UE reports new RSRP measurements, by choosing the θ that retrospectively explains the best past measurements, i.e., that maximizes the likelihood of all RSRP measurements:

$$θ [ i ] = arg {max}_{θ} Pr ( {\{ {RSRP}_{h , v} [ k ] \}}_{{b}_{h , v} ∈ B [ k ] k < i} \vert θ ) \text{(*} )$$

Here, Pr(.) is the joint probability of all past measurements computed with respect to the Gaussian Process with a kernel parameterized by θ.

The problem (*) is non-convex and the Broyden-Fletcher-Goldfarb-Shanno (BFGS) algorithm can be used, being suited to general unconstrained and non-convex optimization problems.

The first step (501) of the method is now described, related to how the GP prior mean and GP kernel hyper-parameters are initialized by the gNB 170 for a new UE 110 popping up in the system at time 0.

Step 1: RSRP inference model initialization. As shown in the previous steps, beams B[i] are selected on the basis of a GP inference model which depends on, amongst other things, the prior mean m(h, v, i), and Kernel function K depending in turn on hyper-parameters θ. Discussed now is how the gNB 170 initializes both quantities for a new UE 110 that connects to the system, based on previous RSRP measurements and GP inferences. For prior mean computation, the gNB has two options: i) non-informative constant mean with no prior information, or ii) informative, exploiting historical data at the gNB.

i. Non-informative: Constant prior mean (no prior info). Here the gNB sets simply m(h, v, i)=constant for all beam indexes h, v and times i. In this case, once a new UE connects, the beam tracking algorithm starts from scratch and, at initial time 0, the beam tracking algorithm explores uniformly at random across the available beams. At later time instants, the beam tracking algorithm leverages past measurements and converges towards the optimal beam.

ii. Informative: Exploit historical data at gNB. Here gNB exploits RSRP measurements from other UEs at previous time slots and sets m(h, v, i)=average RSRP_{h,v} for UEs at previous time slots, for all i≥0.

The rationale behind option ii. for the prior mean computation is that each site is characterized by its UE average geographic distribution corresponding to Pr(UE in z) for each location z, and its scattering geometry, corresponding to RSRP(beam h, v for UE in z), which scattering geometry is relatively stable over time.

Under such assumptions, then

$$m ( h , v , i ) \approx {\sum }_{UE location z} RSRP ( beam , h , v for UE in z ) \times Pr ( UE in z ) = 𝔼 [ {RSRP}_{h , v} \vert site , {∀}_{i}$$

In other words, m(h, v, i) describes how likely beam b_{h,v} is expected to provide good RSRP for an “average” UE that connected to the gNB in the past. For instance, a site with flat geography may have m(h, v, i) low for high vertical indexes v.

Kernel hyper-parameters θ initialization. Good values of 0 are site specific as they depend on the typical UE mobility patterns within the site—for time kernel Kₜᵢₘₑ—and scatterer distribution—which impacts the smoothness of K_{space}.

Therefore, when a new UE pops up in the system, the gNB sets θ[0] as the average optimized θ across all past UEs, in order to avoid any cold start and kick off beam optimization with reasonable values for θ. More specifically, let θ₁, θ₂, . . . , θ_{K} be the hyperparameters optimized for previous UEs. Then, when a new UE pops up in the system, the gNB sets

$$θ [ 0 ] = \frac{1}{K} {\sum }_{i} {θ}_{i} .$$

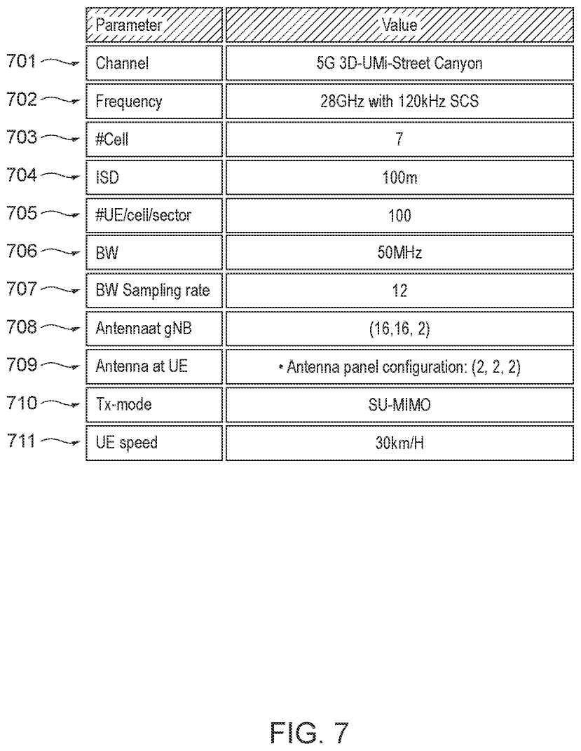

Simulation settings. FIG. 7 is the simulation setup for generating the data. Parameters include channel 701 (set to 5G 3D-UMi-Street Canyon), frequency 702 (set to 28gHz with 120 kHz SCS), number of cells 703 (set at 7), ISD 704 (set at 100m), number of UEs per cell per sector 705 (set to 100), BW 706 (set to 50 MHz), BW sampling rate 707 (set to 12), a gNB antenna configuration 708 (set to (16, 16, 2)), a UE antenna panel configuration 709 (set to (2, 2, 2,)), TX-mode 710 (SU-MIMO), and UE speed 711 (set at 30 km/H).

For the beam grid configuration, the azimuth and elevation angle spread for the beam grid assumption for the gNB are

$$\cdot azimuth angles ( ° ) = [ - 5 6.25 - 48.75 - 4 1.25 - 33.75 - 26.25 - \text{} 18.75 \text{} - 11.25 - 3.75 11.25 18.75 26.25 33.75 41.25 48.75 56.25 ] ;$$

$$\cdot elevation angles ( ° ) = [ 0 7.5 22.5 30 37.5 45 ] ;$$

$$\cdot azimuth / elevation antenna element distance = \frac{1}{2} λ$$

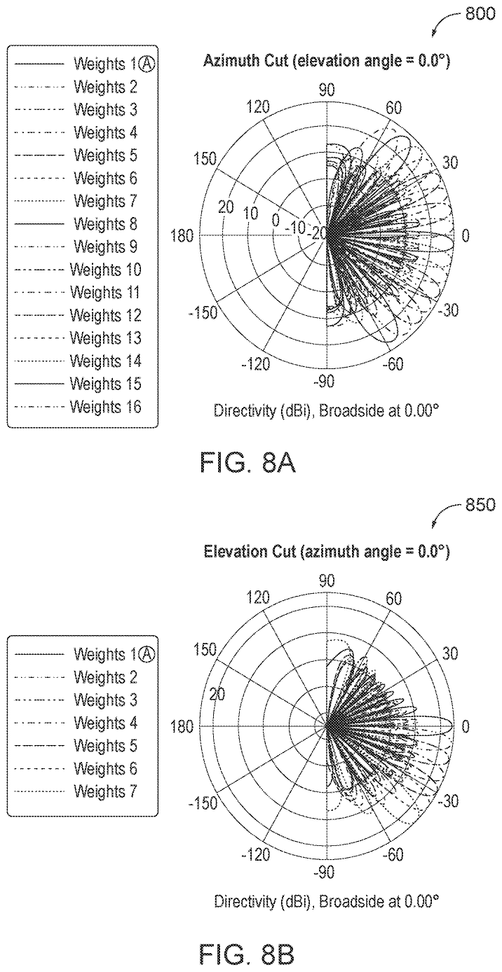

The grid of beams is computed as Kronecker product of the DFT beams. The beam patterns in 0 degree azimuth cut and 0 degree elevation cut are shown in FIG. 8A (item 800) and FIG. 8B (item 850) respectively. In the data collection, the time interval between each two RSRP measurements is 80 ms.

Simulation results. The method was tested on the above simulation results using a worst-case scenario setup, viz. without hyperparameter tuning and non-informative priors (i.e., Step 1—RSRP inference model initialization—is not performed). Adding step 1 would let performance increase. The method was first applied with a fixed beam set size, i.e. step 3/option 3.1, varying the beam set size between 1 and 5 beams per slot (bps). The method was then applied with an optimized beam set size at every slot, i.e. step 3/option 3.2, using the same hyperparameters and non-informative priors as before. In both cases, presented are two metrics: 1) a performance metric measured in dB, which is the gap (lower is better) between the RSRP measured by the proposed beam and that of the optimal beam, which is only available in hindsight, hence not in practice, and 2) a cost metric measured in beams per slot (bps) which is the size of the beam set sampled in a given slot (lower is better).

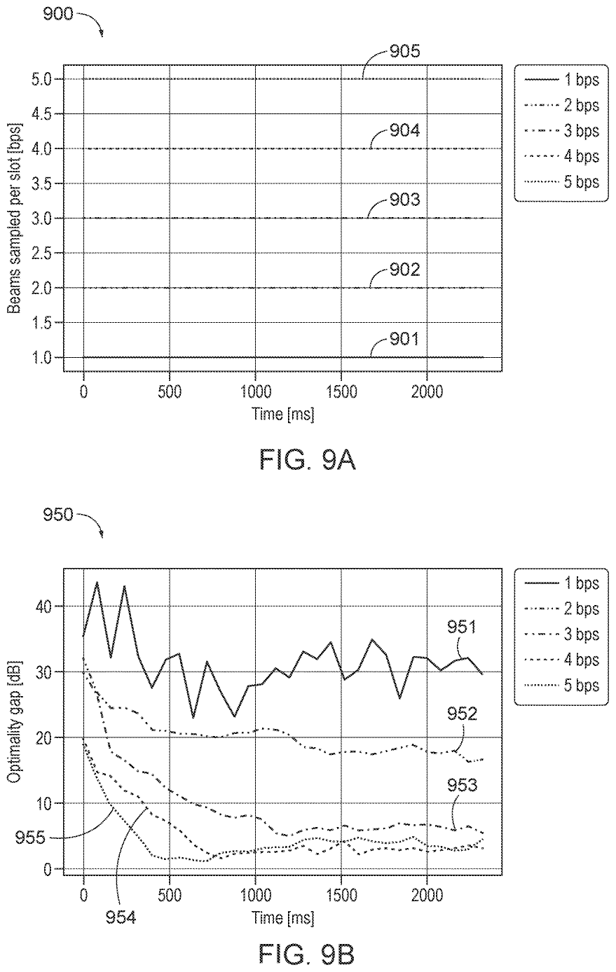

FIG. 9A (graph 900) shows that beams sampled per time slot remains fixed irrespective of performance. FIG. 9B (graph 950) shows the gap in terms of dB loss to the maximum attainable RSRP. In FIG. 9A and FIG. 9B, RSRP measurements are taken every 80 ms. In FIG. 9A, plot 901 corresponds to 1 bps, plot 902 corresponds to 2 bps, plot 903 corresponds to 3 bps, plot 904 corresponds to 4 bps, and plot 905 corresponds to 5 bps. In FIG. 9B, plot 951 corresponds to 1 bps, plot 952 corresponds to 2 bps, plot 953 corresponds to 3 bps, plot 954 corresponds to 4 bps, and plot 955 corresponds to 5 bps.

FIG. 9B shows the optimality gap evolution for the method using step 3/option 3.1. In all cases, the performance improves over time. Increasing the beam set size allows for more beam RSRP measurements per slot, which tightens the variance on the model posterior thereby leading to more rapid convergence towards the minimum optimality gap. The performance of the largest beam set size (5 bps) tested in this simulation converges after approximately 500 ms.

The trade-off for good (and rapidly converging) performance is the increased overhead associated with a larger beam set. This is addressed by step 3/option 3.2, where the method optimizes the beam set size at every slot. In the simulations, the lower limit N for the number of beams used at any slot is set to N=4, while the upper limit is N̅=4, . . . , 15.

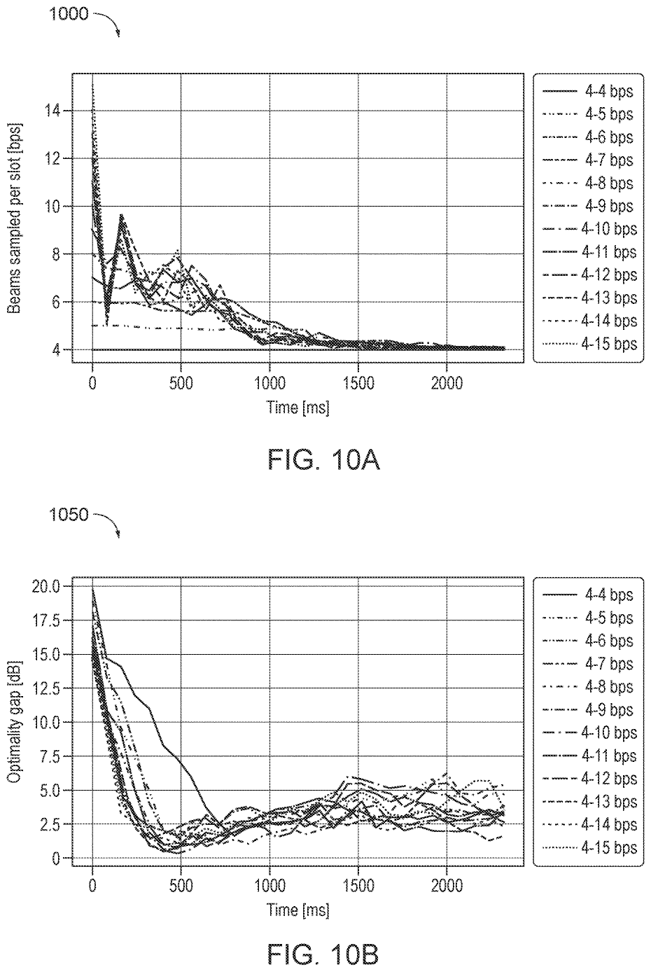

FIG. 10A (graph 1000) shows beams sampled per slot (bps) showing convergence to the minimum allowable beam set size (4 bps) in all cases. FIG. 10B (graph 1050) shows performance in terms of dB loss with respect to the maximum attainable RSRP (only available in hindsight) showing rapid performance convergence. In FIG. 10A and FIG. 10B, RSRP measurements are taken every 80 ms.

FIG. 10A shows that for all ranges, the cost decays to the lower limit 4 bps. FIG. 10B shows a rapid convergence in performance (below 400 ms in most cases, i.e., 4 or 5 slots), demonstrating the core benefit of option 3.2: utilizing a large beam set size initially when model uncertainty is high to quickly achieve good performance, without wasting resources on sampling beams when a good beam has been found and is tracked. In FIG. 10B, there is rapid convergence, then the plots trend upwards a bit away from the convergence. This is because the model initially uses many beams, then gets over-confident so it uses too few beams later on, and then settles on a good trade-off between the number of beams used versus performance. This effect can be attenuated with a better parametrization.

When optimizing the number of beams sampled per slot, the cost decreases as the variance of the model posterior decreases.

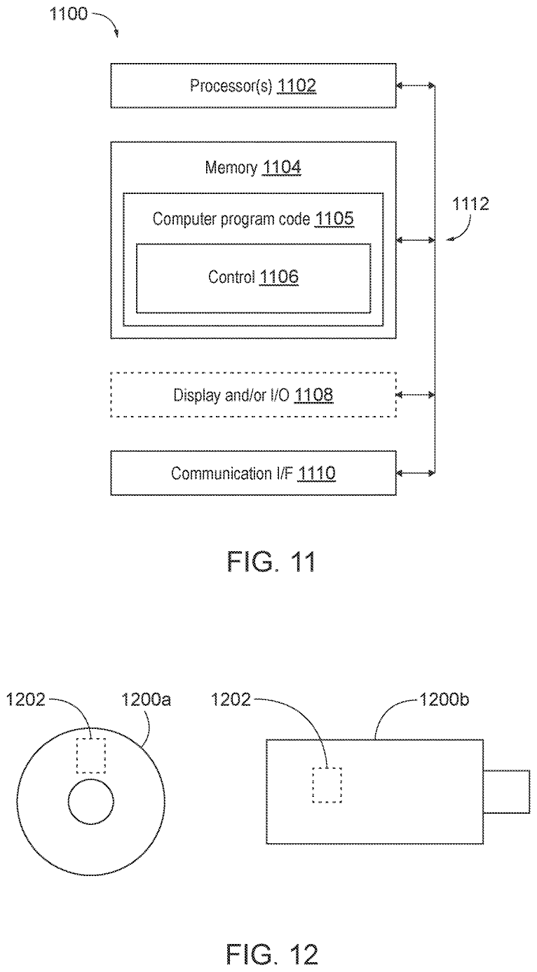

FIG. 11 is an example apparatus 1100, which may be implemented in hardware, configured to implement the examples described herein. The apparatus 1100 comprises at least one processor 1102 (e.g. an FPGA and/or CPU), at least one memory 1104 including computer program code 1105, wherein the at least one memory 1104 and the computer program code 1105 are configured to, with the at least one processor 1102, cause the apparatus 1100 to implement circuitry, a process, component, module, or function (collectively control 1106) to implement the examples described herein, including expected RSRP improvement. The memory 1104 may be a non-transitory memory, a transitory memory, a volatile memory (e.g. RAM), or a non-volatile memory (e.g. ROM).

The apparatus 1100 optionally includes a display and/or I/O interface 1108 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1100 includes one or more communication e.g. network (N/W) interfaces (I/F(s)) 1110. The communication I/F(s) 1110 may be wired and/or wireless and communicate over the Internet/other network(s) via any communication technique. The communication I/F(s) 1110 may comprise one or more transmitters and one or more receivers. The communication I/F(s) 1110 may comprise standard well-known components such as an amplifier, filter, frequency-converter, (de)modulator, and encoder/decoder circuitries and one or more antennas.

The apparatus 1100 to implement the functionality of control 1106 may be UE 110, RAN node 170 (e.g. gNB), or network element(s) 190. Thus, processor 1102 may correspond to processor(s) 120, processor(s) 152 and/or processor(s) 175, memory 1204 may correspond to memory(ies) 125, memory(ies) 155 and/or memory(ies) 171, computer program code 1105 may correspond to computer program code 123, module 140-1, module 140-2, and/or computer program code 153, module 150-1, module 150-2, and/or computer program code 173 or module 177, and communication I/F(s) 1110 may correspond to transceiver 130, antenna(s) 128, transceiver 160, antenna(s) 158, N/W I/F(s) 161, and/or N/W I/F(s) 180. Alternatively, apparatus 1100 may not correspond to either of UE 110, RAN node 170, or network element(s) 190, as e.g. apparatus 1100 may be part of a self-organizing/optimizing network (SON) node, such as in a cloud.

The apparatus 1100 may also be distributed throughout the network (e.g. 100) including within and between apparatus 1100 and any network element (such as a network control element (NCE) 190 and/or the RAN node 170 and/or the UE 110).

Interface 1112 enables data communication between the various items of apparatus 1100, as shown in FIG. 11. For example, the interface 1112 may be one or more buses such as address, data, or control buses, and may include any interconnection mechanism, such as a series of lines on a motherboard or integrated circuit, fiber optics or other optical communication equipment, and the like. Computer program code 1105, including control 1106 may comprise object-oriented software configured to pass data/messages between objects within computer program code 1105. The apparatus 1100 need not comprise each of the features mentioned, or may comprise other features as well.

FIG. 12 shows a schematic representation of non-volatile memory media 1200a (e.g. computer disc (CD) or digital versatile disc (DVD)) and 1200b (e.g. universal serial bus (USB) memory stick) storing instructions and/or parameters 1202 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations, network nodes, or user equipment of the above-described example embodiments.

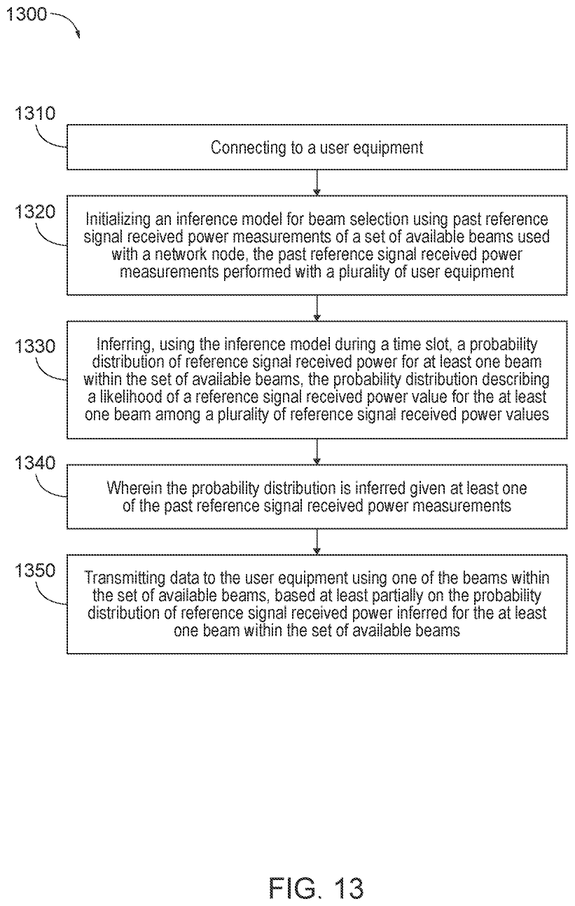

FIG. 13 is an example method 1300. At 1310, the method includes connecting to a user equipment. At 1320, the method includes initializing an inference model for beam selection using past reference signal received power measurements of a set of available beams used with a network node, the past reference signal received power measurements performed with a plurality of user equipment. At 1330, the method includes inferring, using the inference model during a time slot, a probability distribution of reference signal received power for at least one beam within the set of available beams, the probability distribution describing a likelihood of a reference signal received power value for the at least one beam among a plurality of reference signal received power values. At 1340, the method includes wherein the probability distribution is inferred given at least one of the past reference signal received power measurements. At 1350, the method includes transmitting data to the user equipment using one of the beams within the set of available beams, based at least partially on the probability distribution of reference signal received power inferred for the at least one beam within the set of available beams. Method 1300 may be performed with gNB 170.

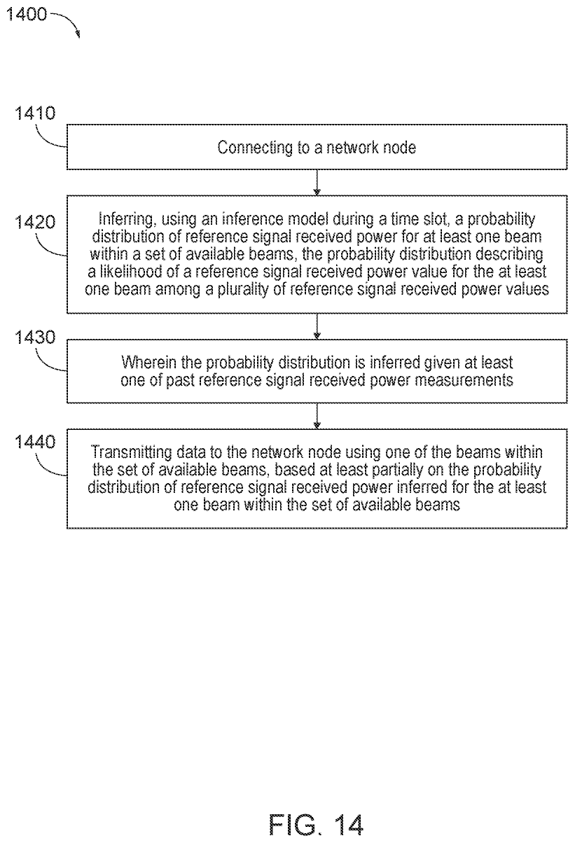

FIG. 14 is an example method 1400. At 1410, the method includes connecting to a network node. At 1420, the method includes inferring, using an inference model during a time slot, a probability distribution of reference signal received power for at least one beam within a set of available beams, the probability distribution describing a likelihood of a reference signal received power value for the at least one beam among a plurality of reference signal received power values. At 1430, the method includes wherein the probability distribution is inferred given at least one of past reference signal received power measurements. At 1440, the method includes transmitting data to the network node using one of the beams within the set of available beams, based at least partially on the probability distribution of reference signal received power inferred for the at least one beam within the set of available beams. Method 1400 may be performed with UE 110.

The following examples (1-78) are provided and described herein.

Example 1. An apparatus including: at least one processor; and at least one memory including computer program code; wherein the at least one memory and the computer program code are configured to, with the at least one processor, cause the apparatus at least to: connect to a user equipment; initialize an inference model for beam selection using past reference signal received power measurements of a set of available beams used with a network node, the past reference signal received power measurements performed with a plurality of user equipment; infer, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmit data to the user equipment using one of the beams within the set of available beams, based at least partially on the probability distribution of reference signal received power inferred for the at least one beam within the set of available beams.

Example 2. The apparatus of example 1, wherein the at least one memory and the computer program code are configured to, with the at least one processor, cause the apparatus at least to: select, from the set of available beams, a set of beams to measure the reference signal received power, based on the probability distribution; and measure the reference signal received power of one or more beams within the set of beams.

Example 3. The apparatus of example 2, wherein the at least one memory and the computer program code are configured to, with the at least one processor, cause the apparatus at least to: transmit, to the user equipment, at least one reference signal for the one or more beams within the selected set of beams; wherein the reference signal received power for the one or more beams within the set of beams is measured following the transmission of the at least one reference signal.

Example 4. The apparatus of any of examples 1 to 3, wherein the at least one memory and the computer program code are configured to, with the at least one processor, cause the apparatus at least to: update at least one parameter of the inference model to increase a probability that a reference signal received power inferred for one or more beams within a selected set of beams is substantially equal to a reference signal received power measured for the one or more beams within the selected set of beams.

Example 5. The apparatus of example 4, wherein the at least one memory and the computer program code are configured to, with the at least one processor, cause the apparatus at least to: determine the probability that the reference signal received power inferred for the one or more beams within the selected set of beams is substantially equal to the reference signal received power measured for the one or more beams within the selected set of beams, with determining a value of the at least one parameter that results in a highest probability of obtaining the past reference signal received power measurements, given the value of the at least one parameter.

Example 6. The apparatus of any of examples 2 to 5, wherein the at least one memory and the computer program code are configured to, with the at least one processor, cause the apparatus at least to: determine an expected improvement to the reference signal received power of the one or more beams within the set of beams; and select, from the set of available beams, the set of beams to measure the reference signal received power, based on the expected improvement.

Example 7. The apparatus of example 6, wherein the at least one memory and the computer program code are configured to, with the at least one processor, cause the apparatus at least to: determine the expected improvement to the reference signal received power of the one or more beams within the set of beams based on a highest reference signal received power achievable with the user equipment when a set of beams is selected with the network node.

Example 8. The apparatus of example 7, wherein the at least one memory and the computer program code are configured to, with the at least one processor, cause the apparatus at least to: determine the expected improvement to the reference signal received power of the one or more beams within the set of beams based at least partially on a difference between at least partially the highest reference signal received power achievable with the user equipment when a set of beams is selected with the network node, and at least partially a highest inferred reference signal received power of the at least one beam.

Example 9. The apparatus of any of examples 2 to 8, wherein a size of the set of beams is used as a criterion for the selection of the set of beams to measure the reference signal received power.

Example 10. The apparatus of example 9, wherein the at least one memory and the computer program code are configured to, with the at least one processor, cause the apparatus at least to: determine the size in advance of the selection of the set of beams, the size of the set of beams being constant.

Example 11. The apparatus of any of examples 9 to 10, wherein the at least one memory and the computer program code are configured to, with the at least one processor, cause the apparatus at least to: select the set of beams to measure the reference signal received power, based on a function of the size of the set of beams for selection, with subtracting at least partially a value of the function from at least partially an expected improvement to the reference signal received power of the one or more beams within the set of beams.

Example 12. The apparatus of any of examples 2 to 11, wherein the at least one memory and the computer program code are configured to, with the at least one processor, cause the apparatus at least to: select the set of beams to measure the reference signal received power, with performing a greedy algorithm.

Example 13. The apparatus of example 12, wherein the greedy algorithm includes: adding a beam to the set of beams for which at least partially an expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam, is highest, while the size of the set is less than a constant number known in advance of the selection.

Example 14. The apparatus of any of examples 12 to 13, wherein the greedy algorithm includes: determining a beam for which at least partially an expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam, is highest, while the size of the set is less than an upper limit on the size of the set of beams; determining an increment including at least partially the expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam; and adding the beam to the set of beams, in response to both the increment being greater than or equal to a threshold, and the size of the set of beams being lower than the upper limit on the size of the set of beams.

Example 15. The apparatus of any of examples 6 to 14, wherein the at least one memory and the computer program code are configured to, with the at least one processor, cause the apparatus at least to: estimate the expected improvement to the reference signal received power of the one or more beams within the set of beams using a method with sampling from the initialized inference model.

Example 16. The apparatus of any of examples 1 to 15, wherein the past reference signal received power measurements are performed with the plurality of user equipment during at least one previous time slot, and the time slot during which the probability distribution is inferred is subsequent to the at least one previous time slot.

Example 17. The apparatus of any of examples 1 to 16, wherein the probability distribution is inferred using a reference signal received power measurement performed during the time slot during which the probability distribution is inferred.

Example 18. The apparatus of any of examples 1 to 17, wherein the at least one of the past reference signal received power measurements used to infer the probability distribution includes at least one past reference signal received power measurement of the connected user equipment.

Example 19. The apparatus of example 18, wherein the at least one past reference signal received power measurement of the connected user equipment includes at least one reference signal received power measurement reported with the connected user equipment for at least one deployed beam during a previous time slot.

Example 20. The apparatus of any of examples 1 to 19, wherein inferring the probability distribution of the reference signal received power for the at least one beam within the set of available beams includes inferring the probability distribution of the reference signal received power of each beam within the set of available beams.

Example 21. The apparatus of any of examples 1 to 20, wherein the at least one memory and the computer program code are configured to, with the at least one processor, cause the apparatus at least to: determine the probability distribution using a Gaussian process, the Gaussian process given with a mean and covariance; wherein the covariance is based on a noise power of the past reference signal received power measurements, a covariance vector between the past reference signal received power measurements and a beam at a next time slot computed using a kernel function, and a covariance matrix across the past reference signal received power measurements, computed using the kernel function.

Example 22. The apparatus of any of examples 1 to 21, wherein the inference model includes at least one kernel function, the kernel function used to measure covariance between one of the past reference signal received power measurements and a reference signal received power of one or more beams within a set of beams selected for measurement of the reference signal received power.

Example 23. The apparatus of example 22, wherein the at least one memory and the computer program code are configured to, with the at least one processor, cause the apparatus at least to: decouple the at least one kernel function into a space kernel function and a time kernel function; wherein the space kernel function describes a similarity of reference signal received power across different beams at any time instant; wherein the time kernel function describes a change to a reference signal received power of a beam between a first time instant and the reference signal received power of the beam at a second time instant, depending on a mobility pattern of the user equipment or dynamics of a scattering environment.

Example 24. The apparatus of any of examples 1 to 23, wherein one or more parameters of the inference model includes at least one of: one or more parameters of at least one kernel function; observation noise; or a prior mean.

Example 25. The apparatus of any of examples 1 to 24, wherein the at least one memory and the computer program code are configured to, with the at least one processor, cause the apparatus at least to: initialize a prior mean of the inference model to be constant.

Example 26. The apparatus of any of examples 1 to 25, wherein the at least one memory and the computer program code are configured to, with the at least one processor, cause the apparatus at least to: initialize a prior mean of the inference model as an average of reference signal received power of the plurality of user equipment at previous time instances.

Example 27. The apparatus of any of examples 1 to 26, wherein the at least one memory and the computer program code are configured to, with the at least one processor, cause the apparatus at least to: initialize at least one parameter of the inference model as an average parameter associated with the plurality of user equipment.

Example 28. The apparatus of any of examples 1 to 27, wherein the at least one memory and the computer program code are configured to, with the at least one processor, cause the apparatus at least to: receive, from the user equipment, at least one current reference signal received power measurement of a measured reception beam associated with one of a selected set of measured beams, the measured reception beam having the highest reference signal received power measurement among reception beams associated with the selected set of beams.

Example 29. The apparatus of any of examples 1 to 28, wherein the at least one memory and the computer program code are configured to, with the at least one processor, cause the apparatus at least to: receive from the user equipment a horizontal index h and a vertical index v of a beam used with the user equipment for reception from the network node.

Example 30. The apparatus of example 29, wherein the at least one memory and the computer program code are configured to, with the at least one processor, cause the apparatus at least to: update the inference model, based on the received horizontal index h and the vertical index v of the beam used with the user equipment.

Example 31. The apparatus of any of examples 1 to 30, wherein the at least one memory and the computer program code are configured to, with the at least one processor, cause the apparatus at least to: determine to transmit data to the user equipment using the one of the beams within the set of available beams, in response to the reference signal received power inferred for the one of the beams within the set of available beams used for transmitting being a highest inferred reference signal received power among the reference signal received power inferred for the at least one beam within the set of available beams.

Example 32. The apparatus of any of examples 2 to 31, wherein the at least one memory and the computer program code are configured to, with the at least one processor, cause the apparatus at least to: determine to transmit the data to the user equipment using the one of the beams within the set of available beams, in response to the reference signal received power measured for the one of the one or more beams used for transmitting data to the user equipment being the highest reference signal received power among the reference signal received power measured for the one or more beams within the set of beams.

Example 33. The apparatus of any of examples 2 to 32, wherein the at least one memory and the computer program code are configured to, with the at least one processor, cause the apparatus at least to: determine to transmit data to the user equipment using the one of the beams within the set of available beams, in response to the reference signal received power inferred for the one of the beams within the set of available beams used for transmitting being higher than the reference signal received power measured for the one or more beams within the set of beams.

Example 34. The apparatus of any of examples 2 to 33, wherein the at least one memory and the computer program code are configured to, with the at least one processor, cause the apparatus at least to: determine to transmit data to the user equipment using the one of the beams within the set of available beams, in response to the reference signal received power measured for the one of the one or more beams used for transmitting data to the user equipment being higher than the reference signal received power inferred for the at least one beam within the set of available beams.

Example 35. The apparatus of any of examples 1 to 34, wherein the one of the beams used for transmitting the data includes a Tx/Rx beam pair.

Example 36. The apparatus of any of examples 1 to 35, wherein the one of the beams used for transmitting the data includes a Tx beam.

Example 37. A user equipment including: at least one processor; and at least one memory including computer program code; wherein the at least one memory and the computer program code are configured to, with the at least one processor, cause the user equipment at least to: connect to a network node; infer, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmit data to the network node using one of the beams within the set of available beams, based at least partially on the probability distribution of reference signal received power inferred for the at least one beam within the set of available beams.

Example 38. The user equipment of example 37, wherein the at least one memory and the computer program code are configured to, with the at least one processor, cause the user equipment at least to: select, from the set of available beams, a set of beams to measure the reference signal received power, based on the probability distribution; and measure the reference signal received power of one or more beams within the set of beams.

Example 39. The user equipment of example 38, wherein the at least one memory and the computer program code are configured to, with the at least one processor, cause the user equipment at least to: transmit, to the network node, at least one reference signal for the one or more beams within the selected set of beams; wherein the reference signal received power for the one or more beams within the set of beams is measured following the transmission of the at least one reference signal.

Example 40. The user equipment of any of examples 37 to 39, wherein the at least one memory and the computer program code are configured to, with the at least one processor, cause the user equipment at least to: update at least one parameter of the inference model to increase a probability that a reference signal received power inferred for one or more beams within a selected set of beams is substantially equal to a reference signal received power measured for the one or more beams within the selected set of beams.

Example 41. The user equipment of example 40, wherein the at least one memory and the computer program code are configured to, with the at least one processor, cause the user equipment at least to: determine the probability that the reference signal received power inferred for the one or more beams within the selected set of beams is substantially equal to the reference signal received power measured for the one or more beams within the selected set of beams, with determining a value of the at least one parameter that results in a highest probability of obtaining the past reference signal received power measurements, given the value of the at least one parameter.

Example 42. The user equipment of any of examples 38 to 41, wherein the at least one memory and the computer program code are configured to, with the at least one processor, cause the user equipment at least to: determine an expected improvement to the reference signal received power of the one or more beams within the set of beams; and select, from the set of available beams, the set of beams to measure the reference signal received power, based on the expected improvement.

Example 43. The user equipment of example 42, wherein the at least one memory and the computer program code are configured to, with the at least one processor, cause the user equipment at least to: determine the expected improvement to the reference signal received power of the one or more beams within the set of beams based on a highest reference signal received power achievable with the network node when a set of beams is selected with the user equipment.

Example 44. The user equipment of example 43, wherein the at least one memory and the computer program code are configured to, with the at least one processor, cause the user equipment at least to: determine the expected improvement to the reference signal received power of the one or more beams within the set of beams based at least partially on a difference between at least partially the highest reference signal received power achievable with the network node when a set of beams is selected with the user equipment, and at least partially a highest inferred reference signal received power of the at least one beam.

Example 45. The user equipment of any of examples 38 to 44, wherein a size of the set of beams is used as a criterion for the selection of the set of beams to measure the reference signal received power.

Example 46. The user equipment of example 45, wherein the at least one memory and the computer program code are configured to, with the at least one processor, cause the user equipment at least to: determine the size in advance of the selection of the set of beams, the size of the set of beams being constant.

Example 47. The user equipment of any of examples 45 to 46, wherein the at least one memory and the computer program code are configured to, with the at least one processor, cause the user equipment at least to: select the set of beams to measure the reference signal received power, based on a function of the size of the set of beams for selection, with subtracting at least partially a value of the function from at least partially an expected improvement to the reference signal received power of the one or more beams within the set of beams.

Example 48. The user equipment of any of examples 38 to 47, wherein the at least one memory and the computer program code are configured to, with the at least one processor, cause the user equipment at least to: select the set of beams to measure the reference signal received power, with performing a greedy algorithm.

Example 49. The user equipment of example 48, wherein the greedy algorithm includes: adding a beam to the set of beams for which at least partially an expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam, is highest, while the size of the set is less than a constant number known in advance of the selection.

Example 50. The user equipment of any of examples 48 to 49, wherein the greedy algorithm includes: determining a beam for which at least partially an expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam, is highest, while the size of the set is less than an upper limit on the size of the set of beams; determining an increment including at least partially the expected improvement to the reference signal received power of the one or more beams within the set of beams determined for the one or more beams using the inference model with the added beam minus at least partially an expected improvement to the reference signal received power of the one or more beams within the set of beams determined for the one or more beams using the inference model without the added beam; and adding the beam to the set of beams, in response to both the increment being greater than or equal to a threshold, and the size of the set of beams being lower than the upper limit on the size of the set of beams.

Example 51. The user equipment of any of examples 42 to 50, wherein the at least one memory and the computer program code are configured to, with the at least one processor, cause the user equipment at least to: estimate the expected improvement to the reference signal received power of the one or more beams within the set of beams using a method with sampling from an initialized inference model.

Example 52. The user equipment of any of examples 37 to 51, wherein the past reference signal received power measurements are performed with the network node during at least one previous time slot, and the time slot during which the probability distribution is inferred is subsequent to the at least one previous time slot.

Example 53. The user equipment of any of examples 37 to 52, wherein the probability distribution is inferred using a reference signal received power measurement performed during the time slot during which the probability distribution is inferred.

Example 54. The user equipment of any of claims 37 to 53, wherein the at least one of the past reference signal received power measurements used to infer the probability distribution includes at least one past reference signal received power measurement of the connected network node.

Example 55. The user equipment of example 54, wherein the at least one past reference signal received power measurement of the connected network node includes at least one reference signal received power measurement reported with the connected network node for at least one deployed beam during a previous time slot.

Example 56. The user equipment of any of examples 37 to 555, wherein inferring the probability distribution of the reference signal received power for the at least one beam within the set of available beams includes inferring the probability distribution of the reference signal received power of each beam within the set of available beams.

Example 57. The user equipment of any of examples 37 to 56, wherein the at least one memory and the computer program code are configured to, with the at least one processor, cause the user equipment at least to: determine the probability distribution using a Gaussian process, the Gaussian process given with a mean and covariance; wherein the covariance is based on a noise power of the past reference signal received power measurements, a covariance vector between the past reference signal received power measurements and a beam at a next time slot computed using a kernel function, and a covariance matrix across the past reference signal received power measurements, computed using the kernel function.

Example 58. The user equipment of any of examples 37 to 57, wherein the inference model includes at least one kernel function, the kernel function used to measure covariance between one of the past reference signal received power measurements and a reference signal received power of one or more beams within a set of beams selected for measurement of the reference signal received power.

Example 59. The user equipment of example 58 wherein the at least one memory and the computer program code are configured to, with the at least one processor, cause the user equipment at least to: decouple the at least one kernel function into a space kernel function and a time kernel function; wherein the space kernel function describes a similarity of reference signal received power across different beams at any time instant; wherein the time kernel function describes a change to a reference signal received power of a beam between a first time instant and the reference signal received power of the beam at a second time instant, depending on a mobility pattern of the user equipment or dynamics of a scattering environment.

Example 60. The user equipment of any of examples 37 to 59, wherein one or more parameters of the inference model includes at least one of: one or more parameters of at least one kernel function; observation noise; or a prior mean.

Example 61. The user equipment of any of examples 37 to 60, wherein the at least one memory and the computer program code are configured to, with the at least one processor, cause the user equipment at least to: initialize a prior mean of the inference model to be constant.

Example 62. The user equipment of any of examples 37 to 61, wherein the at least one memory and the computer program code are configured to, with the at least one processor, cause the user equipment at least to: initialize a prior mean of the inference model as an average of reference signal received power of the network node at previous time instances.

Example 63. The user equipment of any of examples 37 to 62, wherein the at least one memory and the computer program code are configured to, with the at least one processor, cause the user equipment at least to: initialize at least one parameter of the inference model as an average parameter associated with the network node.

Example 64. The user equipment of any of examples 37 to 63, wherein the at least one memory and the computer program code are configured to, with the at least one processor, cause the user equipment at least to: receive, from the network node, at least one current reference signal received power measurement of a measured reception beam associated with one of a selected set of measured beams, the measured reception beam having the highest reference signal received power measurement among reception beams associated with the selected set of beams.

Example 65. The user equipment of any of examples 37 to 64, wherein the at least one memory and the computer program code are configured to, with the at least one processor, cause the user equipment at least to: receive from the network node a horizontal index h and a vertical index v of a beam used with the network node for reception from the user equipment.

Example 66. The user equipment of example 65, wherein the at least one memory and the computer program code are configured to, with the at least one processor, cause the user equipment at least to: update the inference model, based on the received horizontal index h and the vertical index v of the beam used with the network node.

Example 67. The user equipment of any of examples 37 to 66, wherein the at least one memory and the computer program code are configured to, with the at least one processor, cause the user equipment at least to: determine to transmit data to the network node using the one of the beams within the set of available beams, in response to the reference signal received power inferred for the one of the beams within the set of available beams used for transmitting being a highest inferred reference signal received power among the reference signal received power inferred for the at least one beam within the set of available beams.

Example 68. The user equipment of any of examples 38 to 67, wherein the at least one memory and the computer program code are configured to, with the at least one processor, cause the user equipment at least to: determine to transmit the data to the network node using the one of the beams within the set of available beams, in response to the reference signal received power measured for the one of the one or more beams used for transmitting data to the network node being the highest reference signal received power among the reference signal received power measured for the one or more beams within the set of beams

Example 69. The user equipment of any of examples 38 to 68, wherein the at least one memory and the computer program code are configured to, with the at least one processor, cause the user equipment at least to: determine to transmit data to the network node using the one of the beams within the set of available beams, in response to the reference signal received power inferred for the one of the beams within the set of available beams used for transmitting being higher than the reference signal received power measured for the one or more beams within the set of beams.

Example 70. The user equipment of any of examples 38 to 69, wherein the at least one memory and the computer program code are configured to, with the at least one processor, cause the user equipment at least to: determine to transmit data to the network node using the one of the beams within the set of available beams, in response to the reference signal received power measured for the one of the one or more beams used for transmitting data to the network node being higher than the reference signal received power inferred for the at least one beam within the set of available beams.

Example 71. The user equipment of any of examples 37 to 70, wherein the one of the beams used for transmitting the data includes a Tx/Rx beam pair.

Example 72. The user equipment of any of examples 37 to 71, wherein the one of the beams used for transmitting the data includes a Tx beam.

Example 73. A method including: connecting to a user equipment; initializing an inference model for beam selection using past reference signal received power measurements of a set of available beams used with a network node, the past reference signal received power measurements performed with a plurality of user equipment; inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmitting data to the user equipment using one of the beams within the set of available beams, based at least partially on the probability distribution of reference signal received power inferred for the at least one beam within the set of available beams.

Example 74. A method including: connecting to a network node; inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmitting data to the network node using one of the beams within the set of available beams, based at least partially on the probability distribution of reference signal received power inferred for the at least one beam within the set of available beams.

Example 75. An apparatus including: means for connecting to a user equipment; means for initializing an inference model for beam selection using past reference signal received power measurements of a set of available beams used with a network node, the past reference signal received power measurements performed with a plurality of user equipment; means for inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and means for transmitting data to the user equipment using one of the beams within the set of available beams, based at least partially on the probability distribution of reference signal received power inferred for the at least one beam within the set of available beams.

Example 76. An apparatus including: means for connecting to a network node; means for inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and means for transmitting data to the network node using one of the beams within the set of available beams, based at least partially on the probability distribution of reference signal received power inferred for the at least one beam within the set of available beams.

Example 77. A non-transitory program storage device readable by a machine, tangibly embodying a program of instructions executable with the machine for performing operations, the operations including: connecting to a user equipment; initializing an inference model for beam selection using past reference signal received power measurements of a set of available beams used with a network node, the past reference signal received power measurements performed with a plurality of user equipment; inferring, using the inference model during a time slot, a probability distribution of reference signal received power for at least one beam within the set of available beams, the probability distribution describing a likelihood of a reference signal received power value for the at least one beam among a plurality of reference signal received power values; wherein the probability distribution is inferred given at least one of the past reference signal received power measurements; and transmitting data to the user equipment using one of the beams within the set of available beams, based at least partially on the probability distribution of reference signal received power inferred for the at least one beam within the set of available beams.

Example 78. A non-transitory program storage device readable by a machine, tangibly embodying a program of instructions executable with the machine for performing operations, the operations including: connecting to a network node; inferring, using an inference model during a time slot, a probability distribution of reference signal received power for at least one beam within a set of available beams, the probability distribution describing a likelihood of a reference signal received power value for the at least one beam among a plurality of reference signal received power values; wherein the probability distribution is inferred given at least one of past reference signal received power measurements; and transmitting data to the network node using one of the beams within the set of available beams, based at least partially on the probability distribution of reference signal received power inferred for the at least one beam within the set of available beams.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):

| | |
|---|---|
| 2D | two-dimensional |
| 3D | three-dimensional |
| 3GPP | third generation partnership project |
| 4G | fourth generation |
| 5G | fifth generation |
| 5GC | 5G core network |
| AI | artificial intelligence |
| AMF | access and mobility management function |
| argmax | operation that finds the argument that gives the maximum |
| | value from a target function |
| ASIC | application-specific integrated circuit |
| BFGS | Broyden-Fletcher-Goldfarb-Shanno |
| bps | (number of) beams per slot, or beams sampled per slot |
| BW | bandwidth |
| CPU | central processing unit |
| CRI | channel state information reference signal |
| | resource indicator |
| CU | central unit or centralized unit |
| DFT | discrete Fourier transform |
| DSP | digital signal processor |
| DU | distributed unit |
| EI | expected improvement |
| eNB | evolved Node B (e.g., an LTE base station) |
| EN-DC | E-UTRAN new radio - dual connectivity |
| en-gNB | node providing NR user plane and control plane protocol |
| | terminations towards the UE, and acting as a secondary |
| | node in EN-DC |
| E-UTRA | evolved universal terrestrial radio access, i.e., the LTE |
| | radio access technology |
| E-UTRAN | E-UTRA network |
| F1 | interface between the CU and the DU |
| FPGA | field-programmable gate array |
| Gaussian | function of the form f(x) = |
| | 1/(sigmasqrt(2pi))e\hat{ }(−(x − mu)\hat{ }2/(2sigma\hat{ }2)), where |
| | mu is distribution mean and sigma\hat{ }2 is distribution variance, |
| | or a function of the form ae\hat{ }(−(x − b)\hat{ }2/2c\hat{ }2) for |
| | arbitrary real constants a, b, and non-zero c |
| GP | Gaussian process |
| gNB | base station for 5G/NR, i.e., a node providing NR user |
| | plane and control plane protocol terminations towards the |
| | UE, and connected via the NG interface to the 5GC |
| I/F | interface |
| I/O | input/output |
| ISD | inter-site distance |
| λ | wavelength |
| LMF | location management function |
| LTE | long term evolution (4G) |
| MAC | medium access control |
| max | maximum |
| ML | machine learning |
| MME | mobility management entity |
| MRO | mobility robustness optimization |
| NCE | network control element |
| ng or NG | new generation |
| ng-eNB | new generation eNB |
| NG-RAN | new generation radio access network |
| NR | new radio (5G) |
| N/W | network |
| PBCH | physical broadcast channel |
| PDA | personal digital assistant |
| PDCP | packet data convergence protocol |
| PHY | physical layer |
| RAM | random access memory |
| RAN | radio access network |
| RAN1 | RAN meeting |
| RBF | radial basis function |
| Rel- | release |
| RF | radio frequency |
| RIC | RAN intelligent controller |
| RLC | radio link control |
| ROM | read-only memory |
| RP | RAN meeting |
| RRC | radio resource control (protocol) |
| RRH | remote radio head |
| RSRP | reference signal received power |
| RU | radio unit |
| rx/Rx | receiver or reception |
| SCS | subcarrier spacing |
| SDAP | service data adaption protocol |
| SGW | serving gateway |
| SI | study item |
| SMF | session management function |
| SON | self-organizing/optimizing network |
| SS | synchronization signal |
| SSBRI | SS/PBCH block resource indicator |
| SU-MIMO | single-user multiple-input multiple-output |
| TRP | transmission reception point |
| tx/Tx/TX | transmitter or transmission |
| UAV | unmanned aerial vehicle |
| UE | user equipment (e.g., a wireless, typically mobile device) |
| UMi | urban microcell |
| UPF | user plane function |
| X2 | network interface between RAN nodes and between RAN |
| | and the core network |
| Xn | network interface between NG-RAN nodes |

1. An apparatus, comprising:
at least one processor; and
at least one memory;
storing instructions that, when executed with the at least one processor, cause the apparatus at least to:
connect to a user equipment;
initialize an inference model for beam selection using past reference signal received power measurements of a set of available beams used with a network node, the past reference signal received power measurements performed with a plurality of user equipment;
infer, using the inference model during a time slot, a probability distribution of reference signal received power for at least one beam within the set of available beams, the probability distribution describing a likelihood of a reference signal received power value for the at least one beam among a plurality of reference signal received power values;
wherein the probability distribution is inferred given at least one of the past reference signal received power measurements; and
transmit data to the user equipment using one of the beams within the set of available beams, based at least partially on the probability distribution of reference signal received power inferred for the at least one beam within the set of available beams.

2. The apparatus of claim 1, wherein the instructions, when executed with the at least one processor, cause the apparatus at least to:
select, from the set of available beams, a set of beams to measure the reference signal received power, based on the probability distribution; and
measure the reference signal received power of one or more beams within the set of beams.

3. The apparatus of claim 2, wherein the instructions, when executed with the at least one processor, cause the apparatus at least to:
transmit, to the user equipment, at least one reference signal for the one or more beams within the selected set of beams;
wherein the reference signal received power for the one or more beams within the set of beams is measured following the transmission of the at least one reference signal.

4. The apparatus of claim 1, wherein the instructions, when executed with the at least one processor, cause the apparatus at least to:
update at least one parameter of the inference model to increase a probability that a reference signal received power inferred for one or more beams within a selected set of beams is substantially equal to a reference signal received power measured for the one or more beams within the selected set of beams.

5. The apparatus of claim 4, wherein the instructions, when executed with the at least one processor, cause the apparatus at least to:
determine the probability that the reference signal received power inferred for the one or more beams within the selected set of beams is substantially equal to the reference signal received power measured for the one or more beams within the selected set of beams, with determining a value of the at least one parameter that results in a highest probability of obtaining the past reference signal received power measurements, given the value of the at least one parameter.

6. The apparatus of claim 2, wherein the instructions, when executed with the at least one processor, cause the apparatus at least to:
determine an expected improvement to the reference signal received power of the one or more beams within the set of beams; and
select, from the set of available beams, the set of beams to measure the reference signal received power, based on the expected improvement.

7. (canceled)

8. (canceled)

9. The apparatus of claim 2, wherein a size of the set of beams is used as a criterion for the selection of the set of beams to measure the reference signal received power.

10. (canceled)

11. (canceled)

12. (canceled)

13. (canceled)

14. (canceled)

15. (canceled)

16. The apparatus of any claim 1, wherein the instructions, when executed with the at least one processor, perform the past reference signal received power measurements with the plurality of user equipment during at least one previous time slot, and the time slot during which the probability distribution is inferred is subsequent to the at least one previous time slot.

17. The apparatus of claim 1, wherein the probability distribution is inferred using a reference signal received power measurement performed during the time slot during which the probability distribution is inferred.

18. The apparatus of claim 1, wherein the at least one of the past reference signal received power measurements used to infer the probability distribution comprises at least one past reference signal received power measurement of the connected user equipment.

19. The apparatus of claim 18, wherein the at least one past reference signal received power measurement of the connected user equipment comprises at least one reference signal received power measurement reported with the connected user equipment for at least one deployed beam during a previous time slot.

20. The apparatus of claim 1, wherein inferring the probability distribution of the reference signal received power for the at least one beam within the set of available beams comprises inferring the probability distribution of the reference signal received power of the beams within the set of available beams.

21. The apparatus of claim 1, wherein the instructions, when executed with the at least one processor, cause the apparatus at least to:
determine the probability distribution using a Gaussian process, the Gaussian process given with a mean and covariance;
wherein the covariance is based on a noise power of the past reference signal received power measurements, a covariance vector between the past reference signal received power measurements and a beam at a next time slot computed using a kernel function, and a covariance matrix across the past reference signal received power measurements, computed using the kernel function.

22. The apparatus of claim 1, wherein the inference model comprises at least one kernel function, the kernel function used to measure covariance between one of the past reference signal received power measurements and a reference signal received power of one or more beams within a set of beams selected for measurement of the reference signal received power.

23. (canceled)

24. (canceled)

25. The apparatus of claim 1, wherein the instructions, when executed with the at least one processor, cause the apparatus at least to at least one of:
initialize a prior mean of the inference model to be constant;
initialize a prior mean of the inference model as an average of reference signal received power of the plurality of user equipment at previous time instances; or
initialize at least one parameter of the inference model as an average parameter associated with the plurality of user equipment.

26. (canceled)

27. (canceled)

28. The apparatus of claim 1, wherein the instructions, when executed with the at least one processor, cause the apparatus at least to:
receive, from the user equipment, at least one current reference signal received power measurement of a measured reception beam associated with one of a selected set of measured beams, the measured reception beam having the highest reference signal received power measurement among reception beams associated with the selected set of beams.

29. The apparatus of claim 1, wherein the instructions, when executed with the at least one processor, cause the apparatus at least to:
receive from the user equipment a horizontal index h and a vertical index v of a beam used with the user equipment for reception from the network node.

30. (canceled)

31. The apparatus of claim 1, wherein the instructions, when executed with the at least one processor, cause the apparatus at least to:
determine to transmit data to the user equipment using the one of the beams within the set of available beams, in response to the reference signal received power inferred for the one of the beams within the set of available beams used for transmitting being a highest inferred reference signal received power among the reference signal received power inferred for the at least one beam within the set of available beams.

32. (canceled)

33. (canceled)

34. (canceled)

35. A user equipment, comprising:
at least one processor; and
at least one memory
storing instructions that, when executed with the at least one processor, cause the user equipment at least to:
connect to a network node;
infer, using an inference model during a time slot, a probability distribution of reference signal received power for at least one beam within a set of available beams, the probability distribution describing a likelihood of a reference signal received power value for the at least one beam among a plurality of reference signal received power values;
wherein the probability distribution is inferred given at least one of past reference signal received power measurements; and
transmit data to the network node using one of the beams within the set of available beams, based at least partially on the probability distribution of reference signal received power inferred for the at least one beam within the set of available beams.

36. (canceled)

37. A method, comprising:
connecting to a network node;
inferring, using an inference model during a time slot, a probability distribution of reference signal received power for at least one beam within a set of available beams, the probability distribution describing a likelihood of a reference signal received power value for the at least one beam among a plurality of reference signal received power values;
wherein the probability distribution is inferred given at least one of past reference signal received power measurements; and
transmitting data to the network node using one of the beams within the set of available beams, based at least partially on the probability distribution of reference signal received power inferred for the at least one beam within the set of available beams.
